(19) United States
(12) Patent Application Publication
(10) Pub. No.: US 2026/0095859 A1
(43) Pub. Date: Apr. 2, 2026

(54) METHODS ON ZONE-BASED MONITORING OCCASIONS IN LP-WUS SYSTEMS

(71) Applicant: InterDigital Patent Holdings, Inc., Wilmington, DE (US)

(72) Inventors: Nazli Khan Beigi, Longueuil (CA); Young Woo Kwak, Woodbury, NY (US); Moon IL Lee, Melville, NY (US); Jongwoo Hong, New York, NY (US); Prasanna Herath, Laval (CA); Janet Stern-Berkowitz, Little Neck, NY (US); Virgile Garcia, Antibes (FR)

(73) Assignee: InterDigital Patent Holdings, Inc., Wilmington, DE (US)

(21) Appl. No.: 18/901,927

(22) Filed: Sep. 30, 2024

(51) Int. Cl. H04W 52/02; H04W 24/02; H04W 64/00; H04W 68/02; H04W 72/231; H04W 76/20

(52) U.S. Cl. CPC H04W 52/0235; H04W 24/02; H04W 64/00; H04W 68/02; H04W 72/231; H04W 76/20

(57) ABSTRACT

A wireless transmit/receive unit (WTRU) may be configured to receive configuration information for a low power wake-up signal (LP-WUS), which may indicate 1) zone-based LP-WUS being enabled, 2) a zone-type configuration, and 3) an LP-WUS monitoring occasion (MO) configuration of a first set of non-zone-based MOs and a second set of zone-based MOs. The WTRU may be configured to receive, based on the WTRU being within a configured geographical zone, a LP-WUS in an MO of the second set of zone-based MOs. The WTRU may be configured to wake up a main radio receiver based on the received LP-WUS. The configuration information may comprise information regarding a first set of overlaid sequences and associated codepoints. The WTRU may be configured to monitor for the LP-WUS using the second set of zone-based MOs based on a second set of overlaid sequences.

### BACKGROUND

Low-Power-Wake-Up Signal (LP-WUS) monitoring has the potential to reduce power consumption of wireless transmit/receive units (WTRUs) and other small battery powered devices. This may be achieved by using a separate ultra-low power consumption receiver which may monitor wake-up signals (WUSs) and trigger and/or wake-up a main radio receiver (MR) dedicated for data and control signal transmission/reception.

### SUMMARY

A method for use in a wireless transmit/receive unit (WTRU) may comprise receiving configuration information for a low power wake-up signal (LP-WUS). The configuration information may indicate zone-based LP-WUS being enabled. The configuration information may indicate a zone-type configuration. The configuration information may indicate an LP-WUS monitoring occasion (MO) configuration of a first set of non-zone-based MOs and a second set of zone-based MOs. The method may comprise receiving, based on the WTRU being within a configured geographical zone, a LP-WUS in an MO of the second set of zone-based MOs. The method may comprise waking up a main radio receiver based on the received LP-WUS. The configuration information may be received from a network entity. The network entity may be a gNB. The configuration information may be received using the main radio receiver in an on mode. The WTRU may be in a radio resource control connected mode (RRC-Connected). The configuration information may be received in a system information block (SIB), a master information block (MIB), a medium access control-control element (MAC-CE), a downlink control information (DCI), or via radio resource control (RRC) signaling. The zone-type configuration may indicate a geographical zone including latitude and longitude coordinates. The method may comprise determining that the WTRU is within the configured geographical zone based on at least one of: latitude and longitude coordinates, a distance from one or more configured reference points, a Reference Signal Time Difference (RSTD), or one or more radio resource management (RRM) measurements. The configuration information may further comprise information regarding a first set of overlaid sequences and associated codepoints. The method may comprise monitoring for the LP-WUS using the second set of zone-based MOs based on a second set of overlaid sequences. The second set of overlaid sequences may be based on a configured first set of overlaid sequences associated with a codepoint added with a second zone-based sequence that is associated with the configured geographical zone. The method may comprise monitoring a paging occasion (PO) for paging messages and receiving a physical downlink control channel (PDCCH) transmission after turning on the main radio receiver.

A wireless transmit/receive unit (WTRU) may comprise at least one transceiver comprising a main radio receiver and a low power wake up radio receiver (LP-WUR) and a processor. The main radio receiver of the at least one transceiver and the processor may be configured to receive configuration information for a low power wake-up signal (LP-WUS). The configuration information may indicate zone-based LP-WUS being enabled. The configuration information may indicate a zone-type configuration. The configuration information may indicate an LP-WUS monitoring occasion (MO) configuration of a first set of non-zone-based MOs and a second set of zone-based MOs. The processor and the LP-WUR of the at least one transceiver may be configured to receive, based on the WTRU being within a configured geographical zone, a LP-WUS in an MO of the second set of zone-based MOs. The processor may be configured to wake up the main radio receiver of the at least one transceiver based on the received LP-WUS. The configuration information may be received from a network entity. The network entity may be a gNB. The configuration information may be received using the main radio receiver in an on mode. The WTRU may be in a radio resource control connected mode (RRC-Connected). The configuration information may be received in a system information block (SIB), a master information block (MIB), a medium access control - control element (MAC-CE), a downlink control information (DCI), or via radio resource control (RRC) signaling. The zone-type configuration information may indicate a geographical zone including latitude and longitude coordinates. The processor may be further configured to determine that the WTRU is within the configured geographical zone based on at least one of: latitude and longitude coordinates, a distance from one or more configured reference points, a Reference Signal Time Difference (RSTD), or one or more radio resource management (RRM) measurements. The configuration information may further comprise information regarding a first set of overlaid sequences and associated codepoints. The LP-WUR may be further configured to monitor for the LP-WUS using the second set of zone-based MOs based on a second set of overlaid sequences. The second set of overlaid sequences may be based on a configured first set of overlaid sequences associated with a codepoint added with a second zone-based sequence that is associated with the configured geographical zone. The processor and the main radio receiver of the at least one transceiver may be further configured to monitor a paging occasion (PO) for paging messages and receiving a physical downlink control channel (PDCCH) transmission after turning on the main radio receiver.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of a low power wake-up receiver (LP-WUR) architecture;

FIG. 3 shows an example of zone-based low-power wake-up signal (LP-WUS) monitoring occasions (MOs);

FIG. 4 shows an example method of using geographical zone-based low-power wake-up signal (LP-WUS) monitoring occasions (MOs); and

FIG. 5 shows an example method of using geographical zone-based low-power wake-up signal (LP-WUS) monitoring occasions (MOs).

### DETAILED DESCRIPTION

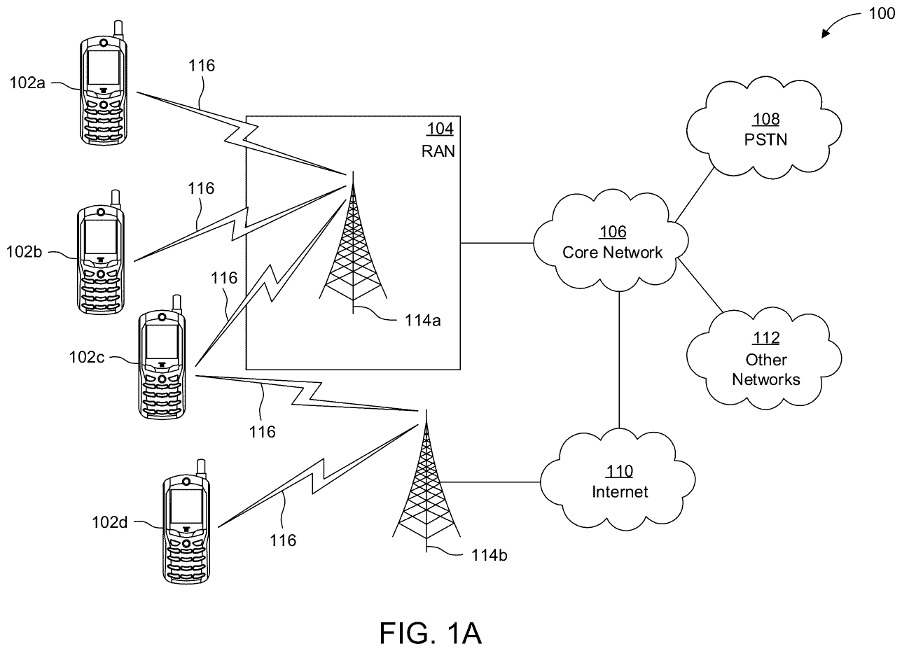

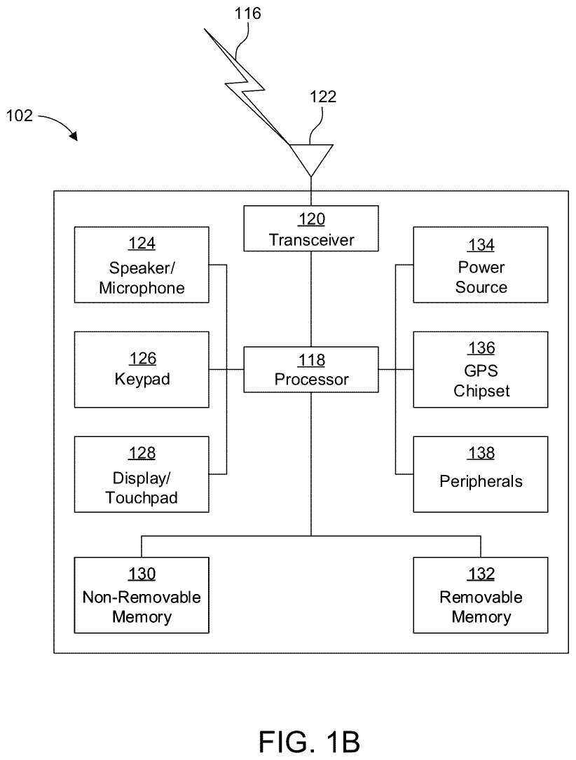

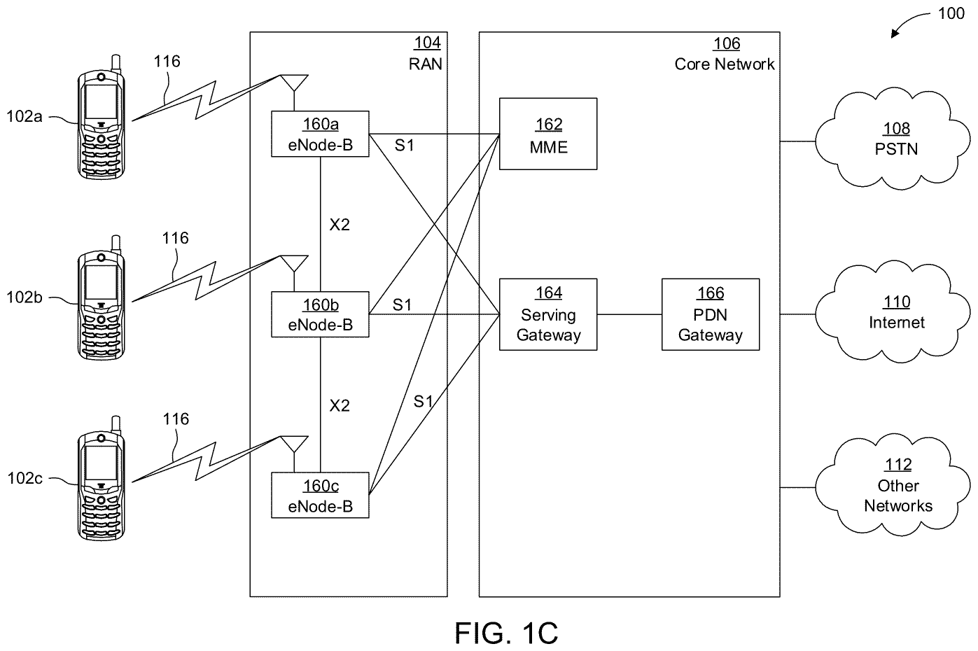

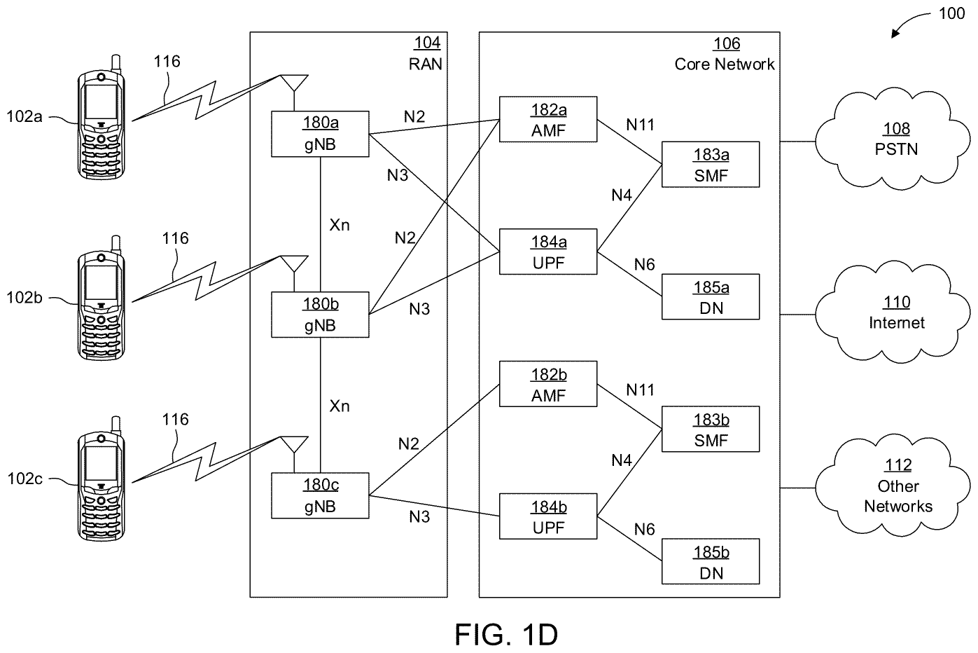

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

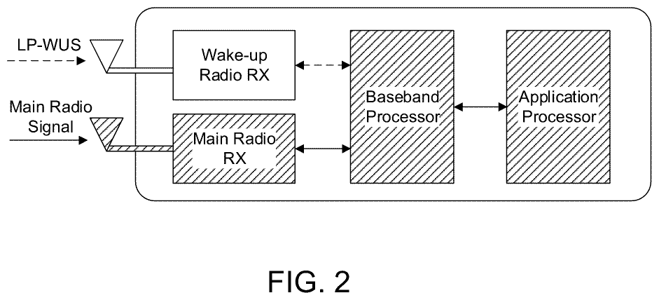

FIG. 2 shows an example architecture of a Low-Power Wake-Up Receiver (LP-WUR). The LP-WUR architecture may comprise a wake-up radio (WUR) receiver (Rx), a main radio (MR) receiver (Rx), a baseband processor, and an application processor. The WUR Rx may be configured to receive a low-power wake-up signal (LP-WUS). The MR Rx may be configured to receive a main radio signal.

A WTRU may use discontinuous reception (DRX) in an RRC_IDLE and an RRC_INACTIVE state in order to reduce power consumption. The WTRU may monitor one paging occasion (PO) per DRX cycle. A PO is a set of physical downlink control channel (PDCCH) monitoring occasions and may comprise multiple time slots (e.g. subframe or OFDM symbol) where a paging downlink control information (DCI) may be sent.

In multi-beam operations, the WTRU may assume that the same paging message and the same short message are repeated in all transmitted beams and thus the selection of the beam(s) for the reception of the paging message and short message is up to WTRU implementation. The paging message may be the same for both radio access network (RAN) initiated paging and core network (CN) initiated paging.

The WTRU may use a paging early indication (PEI) in the RRC_IDLE and RRC_INACTIVE states in order to reduce power consumption. If a PEI configuration is provided in system information, the WTRU in RRC_IDLE or RRC_INACTIVE state supporting a PEI, except for the WTRUs expecting multicast session activation notification, may monitor PEI using PEI parameters in system information.

In multi-beam operations, the WTRU may assume that the same PEI is repeated in all transmitted beams and thus the selection of the beam(s) for the reception of the PEI is up to WTRU implementation.

If the WTRU detects a PEI and the PEI indicates the subgroup the WTRU belongs to monitor its associated PO, the WTRU may monitor the associated PO. If the WTRU does not detect a PEI on the monitored PEI occasion or the PEI does not indicate the subgroup the WTRU belongs to monitor its associated PO, the WTRU is not required to monitor the associated PO.

If a PEI and subgrouping are configured, WTRUs monitoring the same PO may be divided into one or more subgroups. With subgrouping, the WTRU may monitor the associated PO if the corresponding bit for the subgroup the WTRU belongs to is indicated as one by the PEI corresponding to its PO.

LP-WUS systems may leverage beam-based frameworks for enhanced capacity, latency, and coverage, where the LP-WUS code points and/or sequences may be transmitted based on different beam directions and spatial relations. In systems based on a LP-WUS, the LP-WUR may be configured with monitoring occasions (MOs) to monitor and detect potential LP-WUSs. In multi-beam LP-WUS systems, the WTRU may be configured with LP-WUS transmission occasions (LO), where within each LO, one or more LP-WUS MOs may be configured to include all configured beams. At a time, one of the multiple candidate codepoint values may be transmitted in a LP-WUS MO on each beam, which may be associated with one or multiple WTRU subgroups (WSG).

Agreements and assumptions are made in 3GPP RAN1. For LP-WUS monitoring in RRC CONNECTED mode, a LP-WUS may be quasi-colocated (QCLed) with existing NR signal/channel/control resource set (CORESET) for the transmission configuration indication (TCI) state. It is for further study (FFS) which existing NR signal/channel/CORESET is the QCL source of LP-WUS. It is FFS the exact definition of a QCL relationship between a LP-WUS and existing NR signal/channel/CORESET. For LP-WUS monitoring in RRC CONNECTED mode, synchronization signal block (SSB) and/or channel state information (CSI)-reference signal (RS) may be the QCL source of the LP-WUS. If is FFS the applicable QCL type(s).

In RAN #102 the objectives for LP-WUS work-item were approved, where specifying LP-WUS design was one of the items. It was approved to specify the OOK-based (e.g., OOK-1 and/or OOK-4) LP-WUS with overlaid OFDM sequence(s) over OOK symbol.

The following agreements and assumptions are made in 3GPP RAN1: support overlaid OFDM sequence based on existing NR sequence type for LP-WUS; down select among gold sequence, m sequence and ZC sequence; FFS the overlaid OFDM sequence is time or frequency domain sequence; FFS how to reuse the existing sequences; strive to minimize the impact on OOK detection performance; if overlaid OFDM sequence is supported for LP-SS, the same sequence type is used for both LP-SS and LP-WUS; For overlaid OFDM sequences for LP-WUS, support option 1-1 for OOK-4 M>1; Option 1-1: overlaid sequence(s) are the sequence(s) of an OOK on symbol before DFT/LS processing; For overlaid OFDM sequences for LP-WUS, further down-selection between following two options for OOK-1 and OOK-4 with M=1(if supported); Option 1-1: Overlaid sequence(s) are the sequence(s) of an OOK on symbol before DFT/LS processing; Option 2: Overlaid sequence(s) are the sequence(s) of an OFDM symbol before IFFT processing; Different options for OOK-1 and OOK-4 with M=1 (if supported) is not precluded—in which case, it should be deemed necessary.

Considering the procedures in paging and LP-WUS, potential repeating of the same LP-WUS signaling over all beams may be a waste of power at a base station or gNB. Also, due to such beam sweeping of a LP-WUS, even WTRUs that the network does not intend to page will wake up although they may be far away from the WTRUs that the network intends to page. Unnecessary wake up of a MR and associated transition energy from a sleep state to an active state affects power saving, especially when the MR is configured to enter ultra-deep sleep state in an RRC IDLE or RRC_INACTIVE state. Solution for how to avoid unnecessary wake up of WTRUs caused by LP-WUS subgrouping is needed.

A WTRU may be configured with LP-WUS transmission occasions (LO). Within each LO, one or more LP-WUS MOs may be configured to include configured beams (e.g. all configured beams). At a time, one of the multiple candidate codepoint values may be transmitted in a LP-WUS MO on each beam, which may be associated with one or multiple WTRU subgroups (WSG). Moreover, the WTRU may be configured with two types of zones that may be geographical zones or spatial zones, based on, for example, radio quality.

A gNB may not have the precise location of a WTRU and may keep sending repeated/escalating paging/LP-WUS causing power waste in both the gNB and the WTRUs. In multi-beam operations, the WTRU has to wake up the MR frequently, causing a waste of power, due to reception of LP-WUS subgroup indications that are not intended for the WTRU, since the same LP-WUS message is repeated in all transmitted beams.

A WTRU may be configured with one or more “legacy” MOs and “zone-based” MOs for monitoring LP-WUS signaling. The WTRU may determine which MOs to monitor based on the configured zones. The zones may be based on geographical coordinates or spatial beam resources. That is, the WTRU may monitor the “zone-based” MOs, if the WTRU is within the configured areas/zones (e.g., for local/near-by WTRUs), and the WTRU may monitor the “legacy”MOs, if the WTRU is out of range of the configured areas/zones.

If the “local” or “stationary” WTRU only monitors “zone-based” MOs and does not monitor the other non-zone based (e.g. legacy) MOs, the WTRU saves power by not waking up the MR unnecessarily due to repeated or frequent escalated paging/LP-WUS transmission for other WTRUs or subgroups.

In this disclosure, solutions and examples for zone-based monitoring occasions in addition to zone-based codepoints and indications are provided. The solutions and examples provided herein relate to LP-WUS, however, the same solutions and examples may be used for any other type of signaling and indications, for example received by a WTRU from a network entity.

Hereafter, for the brevity of discussion, the zone-based operation, monitoring occasions, and configurations may comprise the indications via a LP-WUS, however the solutions and examples in the disclosure may also apply for cases with other indications and/or signaling types (e.g., paging or DCI).

Herein, ‘a’ and ‘an’ and similar phrases may be interpreted as ‘one or more’ and ‘at least one’. Similarly, any term which ends with the suffix ‘(s)’ may be interpreted as ‘one or more’ and ‘at least one’. The term ‘may’ may be interpreted as ‘may, for example’. A symbol ‘/’ (e.g., forward slash) may be used herein to represent ‘and/or’, where for example, ‘A/B’ may imply ‘A and/or B’. Herein, the terms prediction and estimation may be used interchangeably, and still consistent with this disclosure. Herein, the terms candidate cell, neighbor cell, and target cell may be used interchangeably, and still consistent with this disclosure. Herein, the terms source cell, current cell, and serving cell may be used interchangeably, and still consistent with this disclosure.

A WTRU may transmit or receive information over a physical channel or a reference signal (RS) according to at least one spatial domain filter. The term “beam”may be used to refer to a spatial domain filter.

The WTRU may transmit information over physical channel or a signal using the same spatial domain filter as the spatial domain filter used for receiving an RS (e.g. CSI-RS) or a synchronization signal (SS) block. The WTRU transmission may be referred to as “target”, and the received RS or SS block may be referred to as “reference” or “source”. In such a case, the WTRU may be said to transmit information over the target physical channel or signal according to a spatial relation with a reference to such RS or SS block.

The WTRU may transmit information over a first physical channel or a signal according to the same spatial domain filter as the spatial domain filter used for transmitting information over a second physical channel or a signal. The first and second transmissions may be referred to as “target” and “reference” (or “source”), respectively. In such a case, the WTRU may be said to transmit information over the first (target) physical channel or signal according to a spatial relation with a reference to information over the second (reference) physical channel or signal.

A spatial relation may be implicit, configured by radio resource control (RRC) or signaled by a medium access control (MAC) control element (CE) or downlink control information (DCI). For example, a WTRU may implicitly transmit information over a physical uplink shared channel (PUSCH) and demodulation reference signal (DM-RS) of a PUSCH according to the same spatial domain filter as a sounding reference signal (SRS) indicated by an SRS resource indicator (SRI) indicated in a DCI or configured by RRC. In another example, a spatial relation may be configured by RRC for an SRI or signaled by a MAC CE for a physical uplink control channel (PUCCH). Such spatial relation may also be referred to as a “beam indication”.

The WTRU may receive information over a first (target) downlink channel or a signal according to the same spatial domain filter or spatial reception parameter as information over a second (reference) downlink channel or signal. For example, such association may exist between a physical channel such as a physical downlink control channel (PDCCH) or physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated (e.g. receive an indication of) an association between a CSI-RS or SS block and a DM-RS by an index to a set of TCI states configured by RRC and/or signaled by a MAC CE. Such indication may also be referred to as a “beam indication”.

Herein, a beam resource may comprise a TCI state, CSI-RS, a DL RS, or a SSB for downlink, an SRS resource, an uplink RS, or TCI state for uplink. A beam resource may be identified by a beam indication.

Herein, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), and still consistent with this disclosure. Herein, multi-TRP may be interchangeably used with one or more of MTRP, M-TRP, and multiple TRPs, and still consistent with this disclosure.

A WTRU may report a subset of channel state information (CSI) components. CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, or cell switching.

A WTRU may measure and report the channel state information (CSI). The CSI for each connection mode may include or be configured with one or more of following. CSI Report Configuration, including one or more of the following: CSI report quantity (e.g., Channel Quality Indicator (CQI), Rank Indicator (RI), Precoding Matrix Indicator (PMI), CSI-RS Resource Indicator (CRI), Layer Indicator (LI)); CSI report type (e.g., aperiodic, semi persistent, periodic); CSI report codebook configuration (e.g., Type I, Type II, Type II port selection); CSI report frequency. The CSI for each connection may include or be configured with: CSI-RS Resource Set, including one or more of the following CSI Resource settings: NZP-CSI-RS Resource for channel measurement; NZP-CSI-RS Resource for interference measurement; And CSI-IM Resource for interference measurement. The CSI for each connection may include or be configured with NZP CSI-RS Resources, including one or more of the following: NZP CSI-RS Resource ID; periodicity and offset; QCL Info and TCI-state; and resource mapping (e.g., number of ports, density, CDM type).

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

A parameter that may be included in reference signal measurements may be a SS reference signal received power (SS-RSRP). The SS-RSRP may be measured based on the synchronization signals (e.g., demodulation reference signal (DMRS) in a PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

A parameter that may be included in reference signal measurements may be a CSI-RSRP. The CSI-RSRP may be measured based on the linear average over the power contribution of the resource elements (RE) that carry the respective CSI-RS. The CSI-RSRP measurement may be configured within measurement resources for the configured CSI-RS occasions.

A parameter that may be included in reference signal measurements may be a SS signal-to-noise and interference ration (SS-SINR). The SS-SINR may be measured based on the synchronization signals (e.g., DMRS in a PBCH or SSS). It may be defined as the linear average over the power contribution of the resource elements (RE) that carry the respective synchronization signal divided by the linear average of the noise and interference power contribution. In case a SS-SINR is used for L1-SINR, the noise and interference power measurement may be accomplished based on resources configured by higher layers.

A parameter that may be included in reference signal measurements may be a CSI-SINR. The CSI-SINR may be measured based on the linear average over the power contribution of the resource elements (RE) that carry the respective CSI-RS divided by the linear average of the noise and interference power contribution. In case a CSI-SINR is used for L1-SINR, the noise and interference power measurement may be accomplished based on resources configured by higher layers. Otherwise, the noise and interference power may be measured based on the resources that carry the respective CSI-RS.

A parameter that may be included in reference signal measurements may be a received signal strength indicator (RSSI). The RSSI may be measured based on the average of the total power contribution in configured OFDM symbols and bandwidth. The power contribution may be received from different resources (e.g., co-channel serving and non-serving cells, adjacent channel interference, or thermal noise).

A parameter that may be included in reference signal measurements may be a cross-Link interference received signal strength indicator (CLI-RSSI). The CLI-RSSI may be measured based on the average of the total power contribution in configured OFDM symbols of the configured time and frequency resources. The power contribution may be received from different resources (e.g., CLI, co-channel serving and non-serving cells, adjacent channel interference, or thermal noise).

A parameter that may be included in reference signal measurements may be a sounding reference signals RSRP (SRS-RSRP). The SRS-RSRP may be measured based on the linear average over the power contribution of the resource elements (RE) that carry the respective SRS.

A parameter that may be included in reference signal measurements may be a secondary synchronization signal reference signal received quality (SS-RSRQ). The SS-RSRQ may be measured based on measurements on the reference signal received power (SS-RSRP) and received signal strength (RSSI). In an example, the SS-RSRQ may be calculated as the ratio of N×SS-RSRP/NR carrier RSSI, where N may be determined based on the number of resource blocks that are in the corresponding NR carrier RSSI measurement bandwidth. As such, the measurements to be used in the numerator and denominator may be over the same set of resource blocks.

A parameter that may be included in reference signal measurements may be a CSI reference signal received quality (CSI-RSRQ). The CSI-RSRQ may be measured based on measurements on the reference signal received power (CSI-RSRP) and received signal strength (RSSI). In an example, the SS-RSRQ may be calculated as the ratio of N×CSI-RSRP/CSIRSSI, where N may be determined based on the number of resource blocks that are in the corresponding CSI-RSSI measurement bandwidth. As such, the measurements to be used in the numerator and denominator may be over the same set of resource blocks.

A CSI report configuration (e.g., CSI-ReportConfigs) may be associated with a single BWP (e.g., indicated by BWP-Id), wherein one or more of the following parameters are configured: CSI-RS resources and/or CSI-RS resource sets for channel and interference measurement; CSI-RS report configuration type including periodic, semi-persistent, and aperiodic; CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; time restrictions for channel and interference measurements; report frequency band configuration (e.g. wideband/subband CQI, and PMI); thresholds and modes of calculations for the reporting quantities (e.g. CQI, RSRP, SINR, LI, and RI); codebook configuration; group based beam reporting; CQI table; subband size; non-PMI port indication; and port index.

A CSI-RS resource set (e.g., NZP-CSI-RS-ResourceSet) may include one or more of CSI-RS resources (e.g., NZP-CSI-RS-Resource and CSI-ResourceConfig), wherein a WTRU may be configured with one or more of the following in a CSI-RS Resource: CSI-RS periodicity and slot offset for periodic and semi-persistent CSI-RS resources; CSI-RS resource mapping to define the number of CSI-RS ports, density, CDM-type, OFDM symbol, and subcarrier occupancy; the bandwidth part to which the configured CSI-RS is allocated; and the reference to the TCI-state including the QCL source RS(s) and the corresponding QCL type(s).

One or more of following configurations may be used for a RS resource set. A WTRU may be configured with one or more RS resource sets. The RS resource set configuration may include one or more of following: RS resource set identification (ID); one or more RS resources for the RS resource set; repetition (i.e., on or off); aperiodic triggering offset (e.g., one of 0-6 slots); tracking reference signal (TRS) info (e.g., true or not).

One or more of the following configurations may be used for a RS resource. A WTRU may be configured with one or more RS resources. The RS resource configuration may include one or more of following: RS resource ID; resource mapping (e.g., REs in a physical resource block (PRB)); power control offset (e.g., one value of −8, . . . , 15); power control offset with SS (e.g., −3 dB, 0 dB, 3 dB, 6 Db); scrambling ID; periodicity and offset; QCL information (e.g., based on a TCI state).

A property of a grant or assignment may comprise at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and any parameter provided in a DCI, by MAC or by RRC for the scheduling the grant or assignment.

An indication by a DCI may comprise at least one of the following: an explicit indication by a DCI field or by an radio network temporary identifier (RNTI) used to mask or scramble a cyclic redundancy check (CRC) of the DCI; an implicit indication by a property such as DCI format, DCI size, Coreset or search space, aggregation level, first resource element of the received DCI (e.g., index of the first Control Channel Element (CCE)), where the mapping between the property and the value may be signaled by RRC or MAC.

Receiving or monitoring for a DCI with or using an RNTI may mean that the CRC of the DCI is masked or scrambled with the RNTI.

A WTRU may use a scheduling request (SR) for requesting uplink shared channel (UL-SCH) resources for a new transmission. The WTRU may use an SR for sending one or more requests, indications, and/or reports, for example to a gNB. The WTRU may be configured with zero, one, or more SR configurations. An SR configuration may comprise a set of PUCCH resources for SR across different BWPs and/or cells. In an example, the WTRU may be configured with at most one PUCCH resource for SR per BWP, for example for a logical channel or for a secondary cell (SCell) beam failure recovery and/or for consistent listen before talk (LBT) failure recovery. In another example, the WTRU may be configured with, for example, up to two PUCCH resources for SR per BWP, for example for beam failure recovery of beam failure detection reference signal (BFD-RS) set(s) of a serving cell.

For example, each SR configuration may correspond to one or more logical channels, SCell beam failure recovery, consistent LBT failure recovery, and/or beam failure recovery of a BFD-RS set. In an example, each logical channel, SCell beam failure recovery, beam failure recovery of a BFD-RS set and consistent LBT failure recovery, may be mapped to zero or one SR configuration, which may be configured via RRC.

Hereafter, a signal may be interchangeably used with one or more of following: sounding reference signal (SRS); channel state information-reference signal (CSI-RS); demodulation reference signal (DM-RS); phase tracking reference signal (PT-RS); and synchronization signal block (SSB), and still consistent with this disclosure.

Hereafter, a channel may be interchangeably used with one or more of following: physical downlink control channel (PDCCH); physical downlink shared channel (PDSCH); physical uplink control channel (PUCCH); physical uplink shared channel (PUSCH); and physical random access channel (PRACH), and still consistent with this disclosure.

A WTRU may be operating during at least one of the one or more RRC states and/or RRC modes, for example including RRC-Connected state, RRC-Inactive state, and/or RRC-Idle state.

A WTRU may be operating in an RRC-Connected state, during which the WTRU may have connected, established RRC context, and/or have at least one RRC connection, for example, to one or more cells, base stations, gNBs, or TRPs. In an RRC-Connected state, the WTRU may receive RRC context and/or one or more configuration information at least including one or more radio bearers, logical channels, PDU sessions, and security information. During an RRC-Connected state, the connected WTRU may measure one or more reference signal received power (RSRP), reference signal received quality (RSRQ), or received signal strength indicator (RSSI), based on one or more received, detected, configured, and/or indicated reference signals (RSs) received from a serving cell and/or one or more neighboring cells. The connected WTRU may report the measured parameters, for example to the serving cell.

A WTRU may be operating in an RRC-Idle state, which may be the initial mode when the WTRU is powered up. The WTRU, in an RRC-Idle state, is in a dormant state where the WTRU is not actively engaged in communication. The WTRU in an RRC-Idle state may perform cell selection and/or cell reselection, where the WTRU may receive, detect, measure, and/or select an SSB, based on which the WTRU may use a PBCH, MIB, or SIB, for example. The WTRU in an RRC-Idle state may monitor a PDCCH (e.g., DCI Format 1_0 using a P-RNTI) defined by a discontinuous reception (DRX) pattern. The WTRU may use a respective 5G-S-TMSI to receive paging messages in an RRC-Idle state.

A WTRU may be operating in an RRC-Inactive state, where the WTRU keeps the RRC context and core network connection and does not release the RRC context when switching from an RRC-Connected state to an RRC-Inactive state. The WTRU in an RRC-Inactive state may be in a sleep mode, similar to RRC-Idle state, where the mobility may be handled through cell reselection without involvement of network.

Hereafter, a signal, channel, and message (e.g., as in a DL or UL signal, channel, and message) may be used interchangeably, and still consistent with this disclosure. Hereafter, RS may be interchangeably used with one or more of RS resource, RS resource set, RS port and RS port group, and still consistent with this disclosure. Hereafter, RS may be interchangeably used with one or more of SSB, LP-SS, CSI-RS, SRS, DM-RS, TRS, PRS, and PTRS, and still consistent with this disclosure. Herein, time instance, slot, symbol, and subframe may be used interchangeably, and still consistent with this disclosure. Herein, the terms SSB, SS/PBCH block, PSS, SSS, PBCH, and MIB may be used interchangeably, and still consistent with this disclosure. Herein, SSB, SSB beam, and SSB index may be used interchangeably, and still consistent with this disclosure. Hereafter, the proposed solutions may be used for transmissions and/or receptions belonging to a single or multiple cells, inter-cell, intra-cell, as well as single or multiple TRPs, and still consistent with this disclosure. Hereafter, CSI reporting may be interchangeably used with CSI measurement, beam reporting and beam measurement, and still consistent with this disclosure. Hereafter, a RS resource set may be interchangeably used with a beam group, and still consistent with this disclosure. Herein, RSRP may be used interchangeably with RSSI, RSRQ, SNR, SS-RSRP, CSI-RSRP, SRS-RSRP, RSRP measured based on DMRS in PBCH, RSRP measured based on DMRS in PDCCH, RSRP measured based on DMRS in PDSCH, RSRP measured based on DMRS in PUCCH, RSRP measured based on DMRS in PUSCH, Low-Power RSRP (LP-RSRP), and LP-RSRQ, and still consistent with this disclosure. The solutions provided in this disclosure are based on LP-RSRP or RRM measurements based on detected, received, decoded, and/or measured LP-SS (sequences). The same solutions may be used for scenarios with RRM measurements based on one or more reference signals that may be received, detected, and/or measured via or as part of one or more LP-WUS transmissions, for example LP-WUR. Herein, reference signal (RS) may be substituted for LP-SS or LP-SS sequence and still be consistent with the embodiments and examples described in this disclosure. Herein, the terms “subgroup” and “subgroup ID” may be used interchangeably, and still consistent with this disclosure. Herein, the terms LP-WUS MO and MO may be used interchangeably, and still consistent with this disclosure.

A WTRU may use a (e.g., separate) low power-wake up receiver (LP-WUR) which may monitor low-power wake-up signals (LP-WUS) and trigger and/or wake-up a main radio receiver (MR) dedicated for data and control signal transmission and/or reception. The WTRU may be configured with one or more modes of operation, for example in systems based on LP-WUS. In an example, the WTRU may be configured with a main radio on (MR-ON) mode and a main radio off (MR-OFF) mode. The WTRU may alternate and/or switch between operating in an MR-ON mode and an MR-OFF mode. In an example, the WTRU may save power being in an MR-OFF mode. In another example, the WTRU may enter an MR-ON mode upon receiving an LP-WUS.

The WTRU in an MR-ON mode may turn on the MR and use the MR to send and/or receive channels and signals, for example to and/or from a network node (e.g. Node-B, gNB, base station). The WTRU in an MR-ON mode may monitor, detect, receive and/or measure one or more reference signals, for example SSB, CSI-RS, PT-RS, and DR-RS.

The WTRU in an MR-OFF mode may turn off the MR and may use the LP-WUR to receive one or more low-power signals or channels. For example, the WTRU in an MR-OFF mode may monitor, detect, receive and/or measure one or more Low-Power Synchronization Signaling (LP-SS) and/or LP-WUS. During an MR-OFF mode, the WTRU may monitor to receive and/or detect one or more configured LP-WUS and may wake up the MR and switch to MR-ON mode upon reception of at least one LP-WUS.

The WTRU in an MR-OFF mode, for example, may use a LP-WUR to monitor an LP-SS signal to obtain necessary synchronization. In an example, a WTRU in RRC-Idle and/or RRC-Inactive states in an MR-OFF mode may need to switch to an MR-ON mode and to wake up the MR after receiving and/or detecting the LP-WUS. After waking up the MR and switching to an MR-ON mode, the WTRU may monitor one or more paging occasions (PO), for example to receive paging messages. After receiving a paging message and based on the received paging message, the WTRU may switch to an RRC-Connected state, transmit, and/or receive one or more indicated signals and/or channels. After transmitting and/or receiving the indicated signals and/or channels, the WTRU may turn off the MR and switch back to an MR-OFF mode. In another example, a WTRU in an RRC-Connected state in an MR-OFF mode may need to switch to an MR-ON mode and to wake up the MR after receiving and/or detecting a LP-WUS. After waking up the MR and switching to an MR-ON mode, the WTRU may monitor to receive a PDCCH in one or more configured control channel resource sets (CORESETs) and/or a common search space (CSS). The received PDCCH may include grant indications for one or more uplink and/or downlink transmissions and/or receptions. After transmitting and/or receiving based on the indicated grant indication, the WTRU may turn off the MR and switch back to an MR-OFF mode.

In systems based on a LP-WUS, the WTRU may receive the SSBs during an MR-ON mode, where the WTRU may use the received SSB for synchronization. However, in cases where the MR is configured with a long MR-OFF mode or sleeping periods, the clock frequency may drift at the WTRU. The clock frequency drift or frequency error may result in inaccuracy in a LP-WUR's duty cycle. The difference in a network's clock and a LP-WUR's clock frequency may result in time mismatch between the LP-WUS transmission time from the network and the LP-WUR's monitoring window. The time mismatch may lead to failed detection of a LP-WUS.

To avoid the time mismatch between the LP-WUS transmission time from the network and the LP-WURs monitoring window, the WTRU may be configured to detect and receive one or more LP-SSs to achieve accurate synchronization at the LP-WUR. The LP-SS may be based on On-Off Keying (OOK) symbols forming binary sequences, where the WTRUs with LP-WUS configurations may use the LP-WUR (e.g., based on OOK receivers) to detect and receive a LP-SS.

The WTRU may use the detected, received, and/or measured LP-SS for time and frequency synchronization with one or more of the serving or neighbor cells. Moreover, the WTRU may use the detected, received, and/or measured LP-SS for RRM measurements. As such, the network may configure the LP-SS sequence associated to the serving cell in addition to a number of candidate LP-SS sequences associated with one or more neighbor cells, where the WTRU may measure RRM measurements accordingly, for the serving cell and configured neighbor cells, respectively.

A WTRU may be configured and/or indicated with one or more subgroups. In an example, the WTRU may be configured with one or more LP-WUS subgroups. The WTRU may monitor the LP-WUS and may wake up the MR if the received LP-WUS includes (e.g., an indication to) at least one of the configured and/or indicated subgroups. In an example, the LP-WUS subgrouping may be indicated based on a bitmap indication, where each bit in the bitmap may be associated to one of the LP-WUS subgroup IDs. The LP-WUS subgrouping may be indicated based on a codepoint indication, where each codepoint may be associated to one of the LP-WUS subgroups. The LP-WUS subgrouping may be indicated based on (e.g., overlaid) a sequence indication, where each (e.g., overlaid) sequence may be associated to one of the LP-WUS subgroups. With subgrouping, the WTRU may wake up the MR and/or switch from an MR-OFF to an MR-ON mode if a received and/or detected LP-WUS includes an indication to the subgroup that the WTRU belongs to.

The WTRU may receive, be configured, and/or indicated with one or more configuration information and/or indications on subgroups to which the WTRU belongs. For example, the WTRU may receive, be configured, and/or indicated with one or more subgroup IDs. In an example, the WTRU may be configured and/or indicated to use one or more subgroup IDs based on WTRU_ID based subgrouping. In another example, the WTRU may be configured and/or indicated to use one or more subgroup IDs based on a core network (CN) assigned subgrouping.

The LP-WUS may be based on ON-OFF Keying (OOK) signaling. Alternatively, an overlaid sequence may be applied on top of the OOK symbols in LP-WUS systems. The overlaid OFDM sequence may be adopted to flatten the LP-WUS spectrum for more robust envelope detection of the transmitted LP-WUS in frequency selective channels.

The overlaid OFDM sequences may carry information for the WTRUs whose LP-WUR is capable to detect OFDM sequences. That is, the envelope detector may be considered as the baseline and/or default architecture for LP-WURs (e.g., OOK-based LP-WUR), whereas the, for example OFDM-based, LP-WUR may also detect the information carried by overlaid OFDM sequences. In an example, the overlaid OFDM sequences may carry full wakeup information of the OOK symbols. As such, the WTRU may extract LP-WUS information from the corresponding overlaid OFDM sequences. In another example, the overlaid OFDM sequences may jointly carry wakeup information with OOK symbols. As such, the WTRU may extract different parts of the information of the LP-WUS separately from the OOK symbols and overlaid OFDM sequences. The joint detection may enable faster detection of the entire LP-WUS information and enhance power saving in LP-WUS monitoring.

A WTRU may monitor and receive a wake-up signal (WUS) via a first radio (e.g., a low-power or ultra-low power radio). The WUS may be called a low-power WUS (LP-WUS). The first radio may be called a low-power radio (LR) that may be received via a low power wake-up receiver (LP-WUR). Receiving a WUS (e.g., an LP-WUS), for example via the LR, may trigger wake-up or usage of a second radio of the WTRU (e.g., the WTRU's main radio) for data and/or control signal transmission and/or reception. This has the potential to reduce the power consumption of wireless devices.

LP-WUS for NR is focused on supporting a deep sleep state for the MR while the WTRU is in RRC IDLE or RRC INACTIVE states (referred to as IDLE/INACTIVE mode LP-WUS monitoring) and supporting the WTRU to skip monitoring a PDCCH while in an RRC CONNECTED state (referred to as CONNECTED mode LP-WUS monitoring).

Discontinuous reception (DRX) is used to reduce WTRU power consumption by allowing the WTRU to periodically enter in to a ‘power saving state’ (DRX inactive) during which the WTRU suspends at least PDCCH monitoring. Further, the WTRU may be configured to suspend one or more additional operations (e.g., transmitting (e.g., periodic) CSI reports, L1-RSRP reports) during a DRX inactive time. To monitor and receive PDCCHs which may schedule possible downlink and/or uplink data and/or control transmissions, the WTRU may switch to an ‘active state’ for a limited time (DRX active time). During the ‘active state’, the WTRU may also be configured to perform one or more dynamic and/or configured uplink and/or downlink transmissions and/or receptions, including for example SRS transmission and CSI reporting. Once determined, scheduled, and/or configured uplink/downlink data and/or control transmissions and/or receptions are complete, the WTRU returns to the ‘power saving state’.

A WTRU may, for example periodically, monitor a PDCCH for a downlink control information (DCI) or downlink assignment on a PDCCH masked with a paging RNTI (P-RNTI), for example in an RRC-Idle, RRC-Inactive, and/or RRC-Connected State. When a WTRU detects or receives a DCI or downlink assignment using a P-RNTI, the WTRU may demodulate the associated or indicated PDSCH resource block (RBs) and/or may decode a paging channel (PCH) that may be carried on an associated or indicated PDSCH. A PDSCH which may carry a PCH may be referred to as a PCH PDSCH. Paging, paging message, and PCH may be used interchangeably.

A Paging Frame (PF) and subframe within that PF, for example, a Paging Occasion (PO) that a WTRU may monitor for the paging channel, for example in an RRC-Idle and/or RRC-Inactive State, may be determined based on the WTRU ID (e.g., WTRU_ID) and parameters which may be specified by the network. The parameters may include a paging cycle (PC) length (e.g. in frames) which may be the same as a DRX cycle and another parameter, for example, Node-B, which together may enable the determination of the number of PF per PC and the number of PO per PF which may be in the cell. For example, the WTRU ID may be the WTRU IMSI mod 1024.

From the network perspective, there may be multiple PFs per paging cycle and multiple POs within a PF, for example, more than one subframe per paging cycle may carry a PDCCH masked with a P-RNTI. Additionally, from the WTRU perspective, the WTRU may monitor a PO per paging cycle, and such a PO may be determined based on the parameters specified herein, which may be provided to the WTRU via system information or dedicated signaling information. POs may include pages for one or more specific WTRUs, or they may include system information change pages which may be directed to each of the WTRUs. In an RRC-Idle and/or RRC-Inactive State, a WTRU may receive pages for reasons such as an incoming call or system information update changes. In an RRC-Connected State, a WTRU may receive pages related to system information change, for example, and it may not receive WTRU-specific pages such as those that may be used for an incoming call.

In RRC-Idle and/or RRC-Inactive States a WTRU may monitor for or listen to the paging message to know about one or more of incoming calls, system information change, ETWS (Earthquake and Tsunami Warning Service) notification for ETWS capable WTRUs, CMAS (Commercial Mobile Alert System) notification, or Extended Access Barring parameters modification. A WTRU may monitor a PDCCH for P-RNTI discontinuously, for example to reduce battery consumption when there may be no pages for the WTRU. In an example, the WTRU may be configured with DRX for monitoring PDCCH discontinuously, for example to monitor or listen for a paging message during RRC-Idle and/or RRC-Inactive States, for example for receiving a P-RNTI. In another example, the WTRU may be configured and/or enabled to use DRX in an RRC-Connected State, where the WTRU may monitor the PDCCH discontinuously, for example using DRX operation.

In case a WTRU does not monitor according to a configured PF, PO, or DRX cycle, the WTRU may not receive the transmitted PDCCH and may not perform the granted uplink or downlink transmission or reception. Such cases may happen if the WTRU is outside of the last served cell and cannot receive the paging indications based on the configured PF or PO. In this scenario, the network may initiate paging escalation and/or paging miss procedures. The network may initiate paging escalation if the WTRU misses a first paging, for example, if the first paging attempt is not in the cell where the WTRU is camping. In paging escalation, the network may retransmit the paging message in one or more other cells.

Similar procedure may be considered for LP-WUS messages. That is, a WTRU may miss a first LP-WUS due to the first LP-WUS transmission attempt not being transmitted in the cell where the WTRU is camping. As such, the network may initiate LP-WUS escalating, that is LP-WUS re-transmission in one or more second cells.

A WTRU may use one or more DRX parameters that may be broadcasted, for example in a system information block (SIB), to determine the PF and/or PO to monitor for paging. The WTRU may, for example, alternatively, use one or more WTRU specific DRX cycle parameters that may be signaled to the WTRU, for example via RRC, MAC-CE, or DCI, for example as part of RRC release signaling.

In an example, the WTRU may determine the number of radio frames in the paging cycle based on the configured and/or indicated DRX cycle duration. A larger value of DRX cycle duration may result in less WTRU battery power consumption. A smaller value of DRX cycle duration may increase WTRU battery power consumption. DRX cycle may be cell specific or WTRU specific.

A DRX cycle may be cell specific and may be provided to at least some (e.g., all) WTRUs in a cell. The DRX cycle may be a default paging cycle. A DRX cycle may be WTRU specific. The WTRU may use the smaller of the default paging cycle and the WTRU specific DRX cycle as its DRX or paging cycle.

The WTRU may be configured and/or indicated with the number of POs in a cell specific DRX cycle. The number of POs may be cell specific. The configured and/or indicated number of POs may depend on the paging capacity that may be desired or used in a cell. A larger number of POs may be used, for example to increase paging capacity. A smaller number of POs may be used, for example for a smaller paging capacity.

In an example, the WTRU-specific PO within the PF may be determined from a set of paging subframes. The set may be a function of predefined allowed subframes for paging and/or the number of POs per PF which may be a function of at least the number of POs, the DRX cycle duration, and/or SFN (System Frame Number), where SFN may have a range of values, for example from 0 through 1023.

In an RRC-Connected State, the WTRU may determine a PF and PO in a similar manner as in RRC-Idle and/or RRC-Inactive states. The DRX cycle parameters may be different for RRC-Idle, RRC-Inactive, and/or RRC-Connected states. A WTRU may monitor a (e.g., any) PO in a PC in an RRC-Connected State, for example to obtain system information change information.

Hereafter, MO may be interchangeably used with LO, and still consistent with this disclosure.

A WTRU may receive one or more configuration information and/or indications regarding receiving one or more channels and/or signals. For example, the WTRU may receive configuration information regarding monitoring, detecting, and/or receiving one or more LP-WUS. In an example, the WTRU may be in an RRC-Connected mode, where the WTRU may select at least a (e.g., receive (Rx)) beam direction (e.g., best) (e.g., SSB or CSI-RS) based on one or more measurements (e.g., RSRP). For example, the WTRU may receive the configuration information via RRC, MAC-CE, or DCI. In another example, the WTRU may be in an RRC-Idle and/or RRC-Inactive state, wherein the WTRU may receive, detect, measure, and/or select a (e.g., best) (e.g., Rx) beam direction, for example from a set of one or more SSB bursts. In an example, the WTRU may select the (e.g., best) SSB, based on RRM measurements (e.g., SSB with highest RSRP). For example, the configuration information received as part of the selected SSB may be cell-common and/or group-common. For example, the WTRU may receive the configuration information, for example, on LP-WUS operation, via, for example, a MIB or SIB, based on the selected SSB.

The WTRU may send a report and/or indication on the selected (e.g., best) beam direction (e.g., to a Node-B). For example, the WTRU may send the report while in an RRC-Connected State and before switching to an RRC-Idle and/or RRC-Inactive State. The reporting may be as part of a CSI reporting, via a special SR, uplink control information (UCI), PUCCH, or PUSCH. The reporting of the (best) beam direction may be a handshake between the WTRU and network allowing the network (e.g., Node-B) to select the beam direction for LP-WUS transmission for the case where WTRU may be in MR-OFF mode.

The WTRU may receive one or more of the following configuration information and/or indications.

The WTRU may receive, be configured, and/or indicated with one or more (e.g., general) configuration information and/or indications, for example for LP-WUS operation.

The configuration and/or indications may comprise DRX related configurations. For example, the WTRU may receive, be configured, and/or indicated with one or more DRX related configurations. In an example, the WTRU may be configured with a first short DRX cycle and a second long DRX cycle. In an example, the WTRU may receive configuration information regarding the DRX related operation, that may include but not be limited to DRX occasions, DRX cycle, DRX active time, and DRX inactive time.

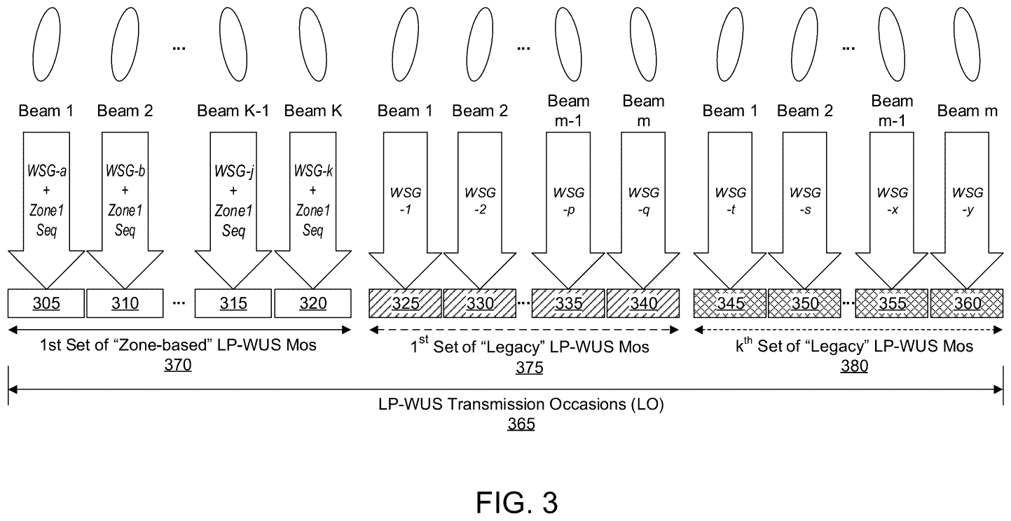

The configuration and/or indications may comprise LP-WUS transmission occasions (LO). For example, the WTRU may receive, be configured, and/or indicated with one or more LP-WUS transmission occasions (LO), for example as shown in FIG. 3. FIG. 3 shows an example zone-based low-power wake-up signal (LP-WUS) monitoring occasions (MOs) (305, 310 . . . 315, 320) in a LP-WUS LO 365. The LP-WUS LO in FIG. 3 comprises three sets of LP-WUS MOs (i.e. 1^{st} set of zone-based LP-WUS MOs 370, 1^{st} set of legacy LP-WUS MOs 375, and kth set of legacy LP-WUS MOs 380. The 1^{st} set of zone based LP-WUS MOs comprise MOs 305, 310 . . . 315, 320. The 1^{st} set of legacy LP-WUS MOs comprise MOs 324, 330 . . . 335, 340. The kth set of legacy LP-WUS MOs comprise MOs 345, 350 . . . 355, 360. In an example, the WTRU may receive, be configured, and/or indicated with time and frequency resources or periodicity for the configured LOs. The LOs may be configured with one or more parameters including at least one of LO periodicity, cell-ID, numerology (e.g., subcarrier spacing), LO length (e.g., number of symbols, slots), and frequency resources (e.g., number of REs, RBs, BWPs, CCs). The WTRU may receive the indications regarding the time and/or frequency resources for one or more LOs based on one or more of the following.

The WTRU may receive the indications regarding the time and/or frequency resources for one or more LOs based on an explicit indication. The explicit indication may be a separate indication. For example, the WTRU may receive, be configured, and/or indicated with one or more LO time resources or LO periodicity. The explicit indication may comprise a time offset with regards to a configured DRX cycle. In an example, the LOs may be configured based on a DRX configuration. That is, the WTRU may be configured and/or indicated with one or more LOs in a DRX inactive time. For example, the WTRU may receive, be configured, and/or indicated with the time offset with regards to the configured DRX active time as the time resources for one or more configured LOs. For example, the indicated and/or configured time offset may be before or after a configured DRX active time. In another example, the indicated and/or configured time offset may be in (e.g. the middle of) a configured DRX inactive time. The explicit indication may comprise a time offset with regards to a paging frame. In an example, the WTRU may receive a frame offset for LP-WUS. For example, the WTRU may receive an offset from the start of a reference frame for LP-WUS (e.g., the start of a frame) to the start of a first paging frame of the paging frames associated with LP-WUS monitoring for the WTRU. Based on the first paging frame, the WTRU may receive a symbol offset to a LP-WUS occasion. For example, the WTRU may receive a symbol offset for the LP-WUS. For example, the WTRU may receive an offset (e.g., in number of symbols) from the start of the frame to the start of the first LP-WUS occasion.

The WTRU may receive the indications regarding the time and/or frequency resources for one or more LOs, based on an implicit indication. For example, in case of absence of configured time and frequency resources for the configured LOs, the WTRU (e.g., implicitly) determines to use one or more default and/or (pre)configured configurations and/or indications for the configured LOs. In an example, the default and/or (pre) configured time resources may be with regards to a reference time instance (e.g., symbol, slot, or frame). For example, the reference time may be with regards to frame 0, the corresponding SSB, or associated DRX active or inactive time. In another example, the default and/or (pre) configured frequency resources may be with regards to a reference frequency. For example, the reference point may be with regards to a lowest PRB and/or middle PRB within the configured CC (Component Carrier) and/or BWP (e.g., initial BWP or active BWP). In another example, in case of absence of configured time and frequency resources for the configured LOs, the WTRU (e.g., implicitly) determines to use one or more configurations and/or indications for one or more paging slots. A paging slot may be configured with one or more parameters including at least one of paging cycle, cell-ID, numerology (e.g., subcarrier spacing), slot length (e.g., regular slot or mini-slot), and frequency resources. The paging slot may be interchangeably used with paging frame, cell-specific paging slot, and paging resources. The paging slot may include a NR-PDCCH for paging monitoring and its associated NR-PDSCH or the paging slot may include NR-PDCCH for paging monitoring only. The LO associated with a paging slot may be indicated based on a time, frequency, and/or an offset from the configured paging frame. For example, LOs may be indicated based on the configured LP-WUS monitoring occasions. In an example, LOs may be a group of configured MOs.

The configuration and/or indications may comprise LP-WUS monitoring occasions (MO) or sets of LP-WUS MOs. For example, a WTRU may receive, be configured, and/or indicated with one or more LP-WUS MOs and/or sets of LP-WUS MOs within a (e.g. each) configured LO, for example as shown in FIG. 3. For example, a set of MOs may include a determined, (pre)configured, and/or indicated number of MOs. In an example, the WTRU may receive, be configured, and/or indicated with time and frequency resources, periodicity, number of MOs, and/or number of sets of MOs for one or more MOs and/or sets of MOs within a (e.g. each) configured LO.

In multi-beam LP-WUS operation, the WTRU may be configured with one or more LP-WUS MOs to monitor for LP-WUS, where the configured MOs may be associated with one or more beam resources. Herein, the beam resources may be SSB, CSI-RS, TCI-state, LP-SS, or LP-WUS. At a time, one of the multiple candidate codepoint values, sequences, or bitmap indications may be transmitted in a set of LP-WUS MOs (e.g., 325-340 and/or 345-360 in FIG. 3) on each beam. Different LP-WUS MOs may be associated with one or more WTRU subgroups (WSG). In an example, the number of MOs within a set of MOs may be associated with the configured number of beam resources, for example associated and/or included in a configured zone. For example, the number of MOs within a set of MOs may be associated with the configured and/or indicated number of transmitted LP-SSs or SSBs.

For example, the set of MOs (325, 330 . . . 335, 340) in FIG. 3 comprises of at least m MOs to include the configured and/or transmitted m beam resources (e.g., LP-SSs or SSBs). At a time, each MO (325, 330 . . . 335, 340) may include indications on one or more WSGs. For example, the MO 325 associated with Beam1 may include indications on WSG-1 that is associated with WTRU subgroup 1, the MO 330 associated with Beam2 may include indications on WSG-2 that is associated with WTRU subgroup 2, and so forth. In an example, an indicated WSG, for example, in an LP-WUS MO, may indicate one or more WTRU subgroups. In another example, an indicated WSG, for example, in an LP-WUS MO, may indicate all WTRU subgroups, for example, as in a common WSG. In FIG. 3, the kth set of legacy LP-WUS MOs (345, 350 . . . 355, 360) show another set of MOs including m MOs associated with m beam resources, where the indicated and/or transmitted WSGs may be similar or different from indicated WSGs in the 1^{st} set of legacy MOs (325, 330 . . . 335, 340). That is, in an example, the MO 345 associated with Beam1 may again include indications on WSG-1, associated with WTRU subgroup 1, similar to the WSG transmitted in the MO 325 associated with Beam1. This case may be due to LP-WUS repetition, paging escalating, or LP-WUS escalating. In another example, the MO 345 associated with Beam1 may include indications on WSG-t, associated with WTRU subgroup t, that is different from the WSG transmitted in the MO 325 associated with Beam1. This case enables supporting larger number of WTRU subgroups per LO and/or corresponding PO.

The WTRU may receive the indications on the time and/or frequency resources for one or more MOs or sets of MOs, based on one or more of the following.

The WTRU may receive the indications on the time and/or frequency resources for one or more MOs or sets of MOs, based on an explicit Indication. For example, the WTRU may receive, be configured, and/or indicated with one or more MO time and/or frequency resources and/or MO periodicity.

The WTRU may receive the indications on the time and/or frequency resources for one or more MOs or sets of MOs, based on an implicit Indication. For example, in case of absence of configured time and frequency resources for the configured MOs, the WTRU (e.g., implicitly) may determine to use one or more default and/or (pre)configured configurations and/or indications for the configured MOs. In an example, the default and/or (pre) configured time resources may be with regards to a reference time instance (e.g., symbol, slot, or frame). For example, the reference time may be with regards to frame 0, the corresponding SSB, or associated LO. In another example, the default and/or (pre) configured frequency resources may be with regards to a reference frequency. For example, the reference point may be with regards to a lowest PRB and/or middle PRB within the associated LO, configured CC (Component Carrier), and/or BWP (e.g., initial BWP, active BWP). For example, a time offset with regards to a paging frame may be used. In an example, the WTRU may receive a frame offset for LP-WUS. For example, the WTRU may receive an offset from the start of a reference frame for LP-WUS (e.g., the start of a frame) to the start of a first paging frame of the paging frames associated with LP-WUS monitoring for the WTRU. Based on the first paging frame, the WTRU may receive a symbol offset to a LP-WUS occasion. For example, the WTRU may receive a symbol offset for LP-WUS. For example, the WTRU may receive an offset (e.g., in number of symbols) from the start of the frame to the start of the first LP-WUS monitoring occasion (e.g., for monitoring LP-WUS).

The configuration and/or indications may comprise subgrouping. For example, the WTRU may receive, be configured, and/or indicated with one or more LP-WUS subgrouping related configurations. The LP-WUS subgrouping related information may be one or more of a number of subgroups for LP-WUS, LP-WUS and/or subgrouping ID. In an example, the WTRU may be indicated with a number of subgroups for LP-WUS. In an example, the WTRU may be indicated that the LP-WUS subgrouping ID is the same as a paging subgrouping ID. In another example, the WTRU may be indicated that the LP-WUS subgrouping ID is different from the configured paging subgrouping ID. For example, the WTRU may be configured and/or indicated to determine, select, and/or calculate the LP-WUS subgrouping ID based on one or more configured paging subgrouping IDs. In another example, the WTRU may determine a subgroup ID based on the configuration of LP-WUS including one or more of number of subgroups and the configured WTRU ID.

In an example, after the WTRU detects and/or receives an LP-WUS, the WTRU may determine if the WTRU's subgroup ID is indicated via the received and/or detected LP-WUS. In case the WTRU's subgroup ID is associated with at least one of the indicated subgroup IDs, received via the LP-WUS, the WTRU may wake up the MR and may switch from an MR-OFF mode to an MR-ON mode. In another example, the WTRU may be configured and/or indicated with one or more common LP-WUS subgrouping IDs, where the common subgrouping ID may be used to wake up the MR for all the WTRUs with all subgroup IDs. As such, in case at least one of the common subgroup IDs is indicated and/or received via LP-WUS, the WTRU may wake up the MR and may switch from MR-OFF mode to MR-ON mode.

In an example, the WTRU may receive, be configured, and/or indicated with one or more configuration information and/or indication on how the subgroup ID may be indicated as part of LP-WUS signaling.

The configuration information and/or indication on how the subgroup ID may be indicated as part of LP-WUS signaling may comprise a codepoint indication. For example, the WTRU may be configured with one or more codepoint values. Each codepoint may be associated with one or more WTRU subgroup IDs. As such, after the WTRU receives and/or detects a transmitted codepoint via a LP-WUS, the WTRU may determine if the WTRU's subgroup ID is indicated via the received and/or detected LP-WUS. In case the WTRU's subgroup ID is indicated via the received LP-WUS, the WTRU may wake up the MR and may switch from an MR-OFF mode to an MR-ON mode.

The configuration information and/or indication on how the subgroup ID may be indicated as part of LP-WUS signaling may comprise a sequence-based indication. In an example, the codepoint values may be associated with one or more sequences, where the sequences may be transmitted as the LP-WUS signaling. In an example, the sequences may be transmitted as overlaid sequences on LP-WUS OOK symbols, as described herein. For example, in a sequence-based indication, a first codepoint value may be associated with a first sequence, a second codepoint value may be associated with a second sequence, as so on. As such, after the WTRU detects and/or receives a transmitted sequence via a LP-WUS, the WTRU may determine if the WTRU's subgroup ID is indicated via the received and/or detected sequence. In case the WTRU's subgroup ID is associated with the indicated sequence, received via the LP-WUS, the WTRU may wake up the MR and may switch from an MR-OFF mode to an MR-ON mode.

The configuration information and/or indication on how the subgroup ID may be indicated as part of LP-WUS signaling may comprise a bitmap indication. In an example, the WTRU may be configured and/or indicated to receive the LP-WUS subgrouping IDs based on a bitmap indication via LP-WUS signaling. For example, each bit in the bitmap may be associated with at least one of the LP-WUS subgroup IDs that is used to wake up the MR in the WTRUs that are configured with the corresponding subgroup ID. In an example, one or more of the bits in the bitmap may be associated with at least one common LP-WUS subgrouping ID, where the common subgrouping ID may be used to wake up the MR for all the WTRUs with all subgroup IDs.

The configuration and/or indications may comprise a payload size of a LP-WUS. For example, the WTRU may receive, be configured, and/or indicated with one or more LP-WUS payload size.

In an embodiment, a WTRU may be configured with a first type of LP-WUS MO. The WTRU may receive, be configured, and/or indicated that a second type of LP-WUS MO is enabled or disabled. In an example, the first type LP-WUS MO may be based on legacy and/or normal LP-WUS MO. In another example, the second type LP-WUS MO may be a zone-based MO. For example, the WTRU may receive a flag or indication that indicates whether the second type LP-WUS MO (e.g., zone-based MO) is enabled. For example, a first value of the received indication (e.g., value one) may indicate that the second type LP-WUS MO is enabled and a second value of the received indication (e.g., value zero) may indicate that the second type LP-WUS MO is disabled or not enabled. In an example, the WTRU may receive the indication via, for example, a MIB, SIB, RRC, MAC-CE, or DCI. For example, the indication may be cell-common, group-specific, and/or WTRU-specific. In an example, the WTRU may receive the indication from a Node-B.

In an embodiment, in case the second type LP-WUS MO (e.g., zone-based MO) is enabled, a WTRU may receive, be configured, and/or indicated with one or more configuration information regarding one or more second type MOs and/or one or more sets of second type MOs. In an example, the WTRU may receive, be configured, and/or indicated with time and frequency resources, time periodicity, and a corresponding LO for receiving the second type MOs. For example, the WTRU may receive the configurations and/or indications via a SIB, RRC, MAC-CE, or DCI, for example from a Node-B.

In an embodiment, a WTRU may determine the time and frequency resources and periodicity for monitoring second type MOs according to the received, configured, and/or indicated configuration information for the first type MOs. Considering that the WTRU is configured with more than one set of LP-WUS MOs in an LP-WUS LO, the WTRU may be configured to consider the configured MOs to be of the first type MOs, unless indicated and/or configured to be of the second type MO. For example, the number of second type MOs and/or second type sets of MOs may be the same in all LOs that include second type MOs. Alternatively, the number of second type MOs and/or second type sets of MOs may be different in different LOs that include second type MOs.

In an example, the WTRU may be (pre)configured with the (e.g., default) location of second type MOs within all configured sets of MOs in an LO. In another example, the WTRU may receive, be indicated, and/or configured with one or more of the following for indicating the location of second type MOs within the (e.g. all) configured sets of MOs in an LO.

The WTRU may receive, be indicated, and/or configured with a LOs indication. In an example, the WTRU may be configured and/or indicated with the LOs during which the second type MOs are configured. For example, the WTRU may be configured with second type MOs to be scheduled in all configured LP-WUS LOs. In another example, the WTRU may be configured with second type MOs to be scheduled in every other LP-WUS LOs (e.g., odd LOs, even LOs, every k-th LO, where k may be configured and/or indicated). The LOs indication may be with respect to a reference point in time and/or frequency, for example frame 0 or the lowest RB within the BWP.

The WTRU may receive, be indicated, and/or configured with a starting index indication: In an example, the WTRU may be configured and/or indicated with a starting index and/or number, as the starting point based on which the WTRU may consider the second type MOs to start within a corresponding LO. For example, the starting index may be indicated as the number of MOs within the corresponding LO. In another example, the starting index may be indicated as the number of sets of MOs within the corresponding LO. For example, in FIG. 3, the WTRU may be configured and/or indicated to consider the first set of MOs within a first LO as the second type MOs.

The WTRU may receive, be indicated, and/or configured with a number of MOs. In an example, the WTRU may be configured and/or indicated with the number of MOs and/or the number of sets of MOs. For example, the WTRU may use the configured number of MOs and/or sets of MOs considering the configured starting indication to determine the second type MOs and/or sets of MOs within a corresponding LO. For example, the number of MOs may be indicated as the number of MOs and/or the number of sets of MOs within the corresponding LO. In an example, the starting index indication and number of MOs indication may be used for indicating the second type MOs in case of consecutive second type MOs in an LO. For example, in FIG. 3, the WTRU may be configured and/or indicated to consider one set of MOs at the start of a first LO as the second type MOs.

The WTRU may receive, be indicated, and/or configured with a bitmap indication. In an example, the WTRU may be configured and/or indicated with a bitmap indication for indicating the second type MOs for a corresponding LO. Each bit in the bitmap may correspond to an MO or a set of MOs within the corresponding LO. For example, in case a first bit in the bitmap has a first value (e.g., value zero) the corresponding first MO or set of first MOs may be considered as first type MOs. In another example, in case a second bit in the bitmap has a second value (e.g., value one) the corresponding second MO or set of second MOs may be considered as second type MOs. In an example, the bitmap indication may be used for indicating the second type MOs in case of nonconsecutive second type MOs in an LO.

In multibeam LP-WUS operation, the WTRU may be configured with one or more second type (e.g., zone-based) LP-WUS MOs to monitor for LP-WUS, where the configured second type MOs may be associated with one or more beam resources. The WTRU monitoring second type (e.g., zone-based) MOs may be configured with one or more subsets of beam resources associated with the determined, configured, and/or indicated zone, in which the WTRU is located and/or included. The WTRU may determine beam-specific MOs for each beam within the configured beam subset based on the configuration information.

At a time, one of the multiple candidate codepoint values, (e.g., overlaid) sequences or bitmap indications may be transmitted in a set of second type LP-WUS MOs (e.g., MOs 305, 310 . . . 315, 320 in FIG. 3) on each beam. Different second type LP-WUS MOs may be associated with one or more WSGs.

In an embodiment, the number of beam resources associated with a second type LP-WUS MO (e.g., zone-based MOs) may be the same or different from the number of beam resources associated with a first type LP-WUS MO (e.g., legacy MOs). In an example, a first zone may include one or more first beam resources, where the first beam resources may be a subset of a total number of beam resources (e.g., LP-SS or SSB), for example K beams in FIG. 3. In an example, the MOs 305, 310 . . . 315, 320 in FIG. 3 comprise at least k MOs to include the configured and/or transmitted k beam resources in the corresponding zone.

Depending on the number of MOs in the second type MOs (e.g. zone-based sets of MOs), the WTRU may determine an integer maximum number of remaining legacy MOs in the corresponding LO. If after an integer number of first type and second type sets of MOs, there are resources remaining in the corresponding LO, no sets of MO may be mapped in the remaining resources.

In an embodiment, a WTRU may receive, be configured, and/or indicated with one or more configuration information and/or indications regarding one or more zone types in addition to one or more configuration information regarding one or more zones corresponding to the configured zone type. For example, the WTRU may be configured with one or more zone types including but not limited to geographic zones and spatial zones. In another example, the WTRU may be configured and/or indicated with one or more threshold values, or delta offset values corresponding to the configured zone type. In an example, the WTRU may receive the configuration information and/or the indication via a MIB, SIB, RRC, MAC-CE, or DCI. For example, the indication may be cell-common, group-specific, and/or WTRU-specific. In an example, the WTRU may receive the indication from a Node-B.

In an example, in case the WTRU is configured with geographical zones, the WTRU may be configured with one or more geographical zones. In an example, the WTRU may receive the configurations based on the WTRU's latest position and/or location, for example before the WTRU falls or moves to an RRC-Idle and/or RRC-Inactive mode. The WTRU may receive one or more of configuration information and/or indications, including but not limited to one or more reference points, threshold values, reference signals (RS), and/or geographical coordinates (e.g., latitude and longitude).

For example, in multi-beam operations, the WTRU may receive configuration information regarding the number of RSs (e.g., LP-SS), the time, frequency, and/or periodicity of RS (e.g., LP-SS) transmissions, associated with the configured geographical zones and/or associated with the cells within the configured geographical zones.

In an example, the WTRU may report the WTRU capability on the maximum number of reference points that the WTRU may support. For example, the WTRU may send the report while the WTRU may be in an RRC-Connected State as part of WTRU capability reporting. The WTRU may send the report before switching and/or falling to an RRC-Idle and/or RRC-Inactive state.

In an example, one or more geographical zones may be configured and/or indicated to be associated with one or more reference points and/or the distance from the corresponding reference points. For example, the WTRU may receive one or more configuration information and/or indications on the associated reference points with one or more determined, configured, and/or indicated geographical zones.

In an example, a WTRU may determine, be configured, and/or indicated with one or more reference points. For example, the reference points may be one or more neighbor cells, TRPs, access points, sidelink WTRUs, and so forth. The WTRU may be configured and/or indicated with one or more configuration information per configured reference point. In an example, the WTRU may receive, be configured, and/or indicated with one or more geographical coordinates (e.g., latitude and longitude, one or more RSs, thresholds, and/or reference points'IDs, corresponding to the configured reference points. For example, the WTRU may be configured and/or indicated with a first geographical zone that may be associated with one or more configured first reference points. The WTRU may be configured and/or indicated with a second geographical zone that may be associated with one or more configured and/or indicated second reference points, and so forth.

In an example, a WTRU may be configured and/or indicated to detect, receive and/or measure one or more RSs from one or more of the determined, configured, and/or indicated reference points. For example, the WTRU may be configured and/or indicated to receive one or more LP-SSs, low-power RSs (LP-RSs), low-power positioning reference signals (LP-PRS), SSB, or CSI-RS. In an example, the WTRU may detect and/or receive one or more LP-SSs, for example as part of an LP-SS burst from one or more of the reference points. In another example, the WTRU may detect and/or receive one or more LP-RSs, LP-PRS, or SSB from one or more reference points. For example, the WTRU may receive the configuration information on the time and frequency resources, periodicity, on the transmission of the RSs from different reference points, via, for example, a SIB, RRC, MAC-CE, or DCI, for example via a PBCH, PDCCH, PDSCH, physical sidelink control channel (PSCCH), or physical sidelink shared channel (PSSCH).

In an example, the WTRU may receive one or more configuration information and/or indicated based on the received RSs. For example, the WTRU may receive and/or determine a cell ID and/or reference point's ID based on one or more received RSs. The WTRU may use the received and/or determined cell ID and/or reference point's ID to determine the WTRU's position with respect to one or more reference points. In an example, the WTRU may determine the reference point's ID based on the sequence and/or codepoint received as part of the received and/or detected RS. For example, the WTRU may determine the reference point's ID based on the sequence and/or codepoint that is used for the corresponding RS. In an example, the WTRU may determine that a detected and/or received first RS with a first sequence and/or codepoint is transmitted from a first reference point. The WTRU may determine that a detected and/or received second RS with a second sequence and/or codepoint is transmitted from a second reference point. In another example, the WTRU may determine the reference point's ID based on the received and/or detected RS ID. For example, the WTRU may determine that a detected and/or received first PRS (e.g., DL-PRS, Sidelink PRS (SL-PRS), or LP-PRS) with a first PRS resource ID is transmitted from a first reference point. The WTRU may determine that a detected and/or received second PRS with a second PRS resource ID is transmitted from a second reference point.

In an example, one or more geographical zones may be indicated based on one or more configured latitude and longitude coordinates. For example, the indicated latitude and longitude coordinates for the geographical zones may be associated with one or more configured zones. In an example, the WTRU may be configured and/or indicated with one or more first geographical coordinates for a first zone. The WTRU may be configured and/or indicated with one or more second geographical coordinates for a second zone.

For example, the WTRU may receive a number (e.g., four) latitude and longitude coordinates associated with a configured shape (e.g., rectangle) for a first configured zone. In an example, the WTRU may receive a first coordinate for the left side of the configured shape, a second coordinate for the right side of the configured shape, a third coordinate for the top side of the configured shape, a fourth coordinate for the bottom side of the configured shape, for example for the first configured shape. In an example, the WTRU may be configured and/or indicated with cell-based and/or geographical coordinates. In another example, the WTRU may be configured and/or indicated with estimated errors for determining the corresponding coordinates. In an example, the WTRU may use, estimate, and/or measure the corresponding coordinates, for example by using an application, (e.g., GPS). The WTRU may apply a location determination algorithm using databases of the references points.

In an example, a WTRU may be configured with one or more delta coordinates for determining one or more geographical zones. For example, the delta coordinates may be indicated with respect to WTRU's location for the geographical zone that the WTRU is located within. For example, the WTRU may receive a number (e.g., four) of latitude and longitude coordinates associated with a configured shape (e.g., rectangle) for the geographical zone that the WTRU is located. In an example, the WTRU may receive a first coordinate for the left side of the configured shape, a second coordinate for the right side of the configured shape, a third coordinate for the top side of the configured shape, a fourth coordinate for the bottom side of the configured shape.

In an example, in case the WTRU is configured with a spatial zone type, the WTRU may determine, be configured, and/or indicated with one or more spatial zones in a beam-specific manner. In an example, the WTRU may receive the configurations based on the WTRU's latest beam direction and/or TCI-state that was used by the WTRU, for example before the WTRU falls to or switches to an RRC-Idle and/or RRC-Inactive mode. For example, the WTRU may be configured with one or more spatial zones, where each zone may be associated with one or more beam resources, beam subsets, or beam groups. The configured beam resources, beam subset, and/or beam groups may include and/or be associated with beam resources, where the beam resources may be non-overlapped or partially overlapped. The spatial zone may be interchangeably used with beam subset, beam tracking area, beam group, low-power (LP) beam group, LP beam subset, LP beam tracking area, paging beam group, paging beam tracking area, and paging beam subset.

The WTRU may determine, be configured, and/or indicated with one or more spatial zones, where each spatial zone may include a set of beam resources (e.g., DL/UL beam resources, SL beam resources). The WTRU may receive one or more configuration information regarding the beam resources, beam sets, and/or beam groups associated with a (e.g. each) spatial zone, for example including but not limited to one or more RS indexes (e.g., LP-SS, SSB, CSI-RS), QCL types, and TCI states.

One or more spatial zone may be (pre)determined or (pre)defined and one of the spatial zones may be determined or selected, wherein for example, a spatial zone may be selected or determined based on a radio quality measurement, for example of one or more beam resources (e.g., LP-SS, SSB). For example, a WTRU may measure radio quality (e.g., LP-RSRP, LP-RSRQ, RSRP, RSRQ) of one or more beam resources (e.g., LP-SS, SSB) and the WTRU may determine a beam (e.g., LP-SS, SSB) which may provide highest radio and/or beam quality. The WTRU may select a spatial zone which may include the corresponding determined beam (e.g., LP-SS, SSB).

In an embodiment, a spatial zone index may be used, where the RSs may include indications for the spatial zone. For example, the PBCH in an SS block may include the spatial zone's index; the sequence and/or the codepoint used in LP-SS may include the spatial zone's index. One or more of following may apply. The number of spatial zone's IDs may be determined based on the number of beams used in an SSB and/or LP-SS burst. For example, the number of LP-SS in an SS burst may be used to determine the number of spatial zone's IDs. The beam resources in a spatial zone may be localized in the spatial domain. The beams in a spatial zone may be evenly distributed in the spatial domain.

A WTRU may receive one or more configuration information and/or indications (e.g., via RRC signaling, MAC-CE indication, DCI indication, or SI) enabling, allowing and/or triggering the WTRU to start monitoring LP-WUS in second type (e.g., zone-based) MOs. In an example, the WTRU may receive one or more RRC release messages indicating to activate LP-WUS monitoring in one or more configured second type (e.g., zone-based) MOs.

The WTRU may enter an MR-OFF mode, wherein the WTRU may monitor LP-SS or LP-WUS while the WTRU may be in an RRC-IDLE, RRC INACTIVE, and/or RRC CONNECTED state. The WTRU may consider the cell that the WTRU had last camped on and/or was last connected to as the “last used cell”. In an example, the WTRU may enter the MR-OFF mode after a determined, indicated, and/or (pre)configured time offset from receiving, for example, an RRC release message and/or after receiving an indication and/or configuration for LP-WUS monitoring.

In an embodiment, a WTRU configured with second type (e.g., zone-based) MOs may determine if the WTRU is in-zone or out-of-zone based on the configured zone, in addition to one or more indications, configurations, or thresholds. For example, the WTRU may monitor for detecting and/or receiving LP-WUS in second type (e.g., zone-based) MOs when the WTRU is located within the configured zone. In an example, the WTRU may be configured with a geographical zone and/or spatial zone, where the configured zone may be associated with the configured second type (e.g., zone-based) MOs. In an example, the WTRU may monitor first type (e.g., legacy) MOs for receiving LP-WUS, if the WTRU determines that the WTRU is out of the configured zone. In an example, the WTRU may (e.g., periodically) detect, receive, measure one or more RSs (e.g., LP-SS, SSB), wherein the WTRU may determine if the WTRU is within the configured zone or if the WTRU is out of the configured zone (e.g., due to WTRU moving out of the configured zone). To this end, WTRU may use one or combination of the following solutions.

A WTRU that is configured with second type (e.g., zone-based) MOs based on geographical zones, may use one or combination of the following steps or procedures to determine if the WTRU is in-zone or out-of-zone with respect to the configured zone.

The WTRU may determine if the WTRU is in-zone or out-of-zone with respect to a configured zone based on geographical coordinates. For example, the WTRU may determine the WTRU's geographic coordinates based on one or more of the following examples. The WTRU may determine its geographical coordinates by using global navigation satellite system (GNSS) and/or or global positioning system (GPS). The WTRU may be configured with its geographical coordinates or location as a part of configuration received when WTRU is configured or installed. The WTRU may receive geographical coordinates or a location from the network. For example, as a part of initial configuration, the WTRU may receive geographical location and/or coordinates (e.g., via subscriber identity module (SIM), soft SIM). A WTRU which is fixed (e.g. not moving) may receive its zone (e.g., ID of a zone) from the network.

The WTRU may determine if the WTRU is inside the configured zones or out of zone based on the determined geographical coordinates and/or location. For example, if the WTRU's determined and/or configured geographic coordinates are within the configured zone's coordinates, the WTRU may determine that the WTRU may be in-zone. Otherwise, if the WTRU's determined and/or configured geographic coordinates are outside of the configured zone's coordinates, the WTRU may determine that the WTRU may be out-of-zone.

The WTRU may determine if the WTRU is in-zone or out-of-zone with respect to a configured zone based on a distance to or with the reference points. For example, a WTRU may determine, calculate, and/or estimate WTRU's position with regards to one or more configured reference points (e.g., NodeB, TRP, sidelink WTRU). The WTRU may determine WTRU's distance to the corresponding reference points based on the determined, calculated, and/or estimated WTRU's position and the determined, configured, and/or indicated geographical position and/or coordinates of the reference points. In an example, the WTRU may use and/or apply a location determination algorithm using databases of the estimated position's references points. In another example, the WTRU may use the antenna configuration and/or orientation for determining WTRU's location.

In an example, the WTRU may determine that the WTRU is within a first geographical zone if the calculated distance from at least one of the determined, configured, and/or indicated associated first reference points is lower than a corresponding configured, determined, and/or indicated threshold. In another example, the WTRU may determine that the WTRU is not within (e.g., out of) a second geographical zone if the calculated distances from all of the determined, configured, and/or indicated associated second reference points are larger than the corresponding thresholds.

In another example, the WTRU may receive, determine, and/or be configured with a first geographic location and/or coordinates, for example based on the last used cell, for example when the WTRU switched to an MR-OFF mode. The WTRU may (e.g., periodically) receive and/or determine a second geographic location and/or coordinates based on WTRU's current location, where the WTRU may calculate and/or determine the distance between the first and second coordinates. In case the calculated distance does not exceed a determined, indicated, and/or (pre)configured distance threshold, the WTRU may determine that the WTRU is in-zone with respect to the configured zone. In case the calculated distance exceeds the distance threshold, the WTRU may determine that the WTRU is out of the configured zone.

The WTRU may determine if the WTRU is in-zone or out-of-zone with respect to a configured zone based on a Reference Signal Time Difference (RSTD). For example, a WTRU may detect, receive, and/or measure one or more DL reference signals (RS) received from one or more reference points. In an example, the received and/or measured RSs may be LP-SS, low-power RS (LP-RS), low-power positioning reference signal (LP-PRS), SSB, or CSI-RS. The WTRU may measure the RSTD based on the received RSs, for example along with knowledge of the downlink timing of the corresponding reference points.

In an embodiment, the WTRU may determine that the WTRU is within a first geographical zone if the measured RSTD of at least one of the associated first reference points is lower than a corresponding configured, determined, and/or indicated threshold. In an embodiment, the WTRU may determine that the WTRU is not within (e.g., out of) a second geographical zone if the measured RSTDs based on all of the determined, configured, and/or indicated associated second reference points are larger than the corresponding thresholds.

The WTRU may determine the WTRU's position and/or distance with regards to the corresponding reference points based on the measured RSTD, for example along with knowledge of the geographical coordinates of the reference points and their relative downlink timing. The WTRU may use the determined position and/or distance to determine if the WTRU is within the configured geographical zones, as described herein.

The WTRU may determine if the WTRU is in-zone or out-of-zone with respect to a configured zone based on RRM Measurements. As an example, the WTRU may determine that the WTRU is within a first geographical zone if the WTRU is within the coverage zone of the configured one or more first reference points. For example, the WTRU may determine that the WTRU is within the coverage zone of one or more configured first reference points, based on one or more RRM measurements, for example based on one or more determined, configured, and/or indicated reference signals (RS). In an example, in case the measured received power (e.g., RSRP, RSRQ, LP-RSRP, LP-RSRQ) based on a first RS received from a first reference point is higher than a corresponding configured threshold, the WTRU may determine that the WTRU may be within the coverage zone of the first reference point. In another example, in case the measured received power (e.g., RSRP, RSRQ, LP-RSRP, LP-RSRQ) based on the first RS received from the first reference point is lower than the corresponding configured threshold, the WTRU may determine that the WTRU may not be within the coverage zone of the first reference point. In an example, the WTRU may be configured to determine that the WTRU may be within a configured geographical zone in case the WTRU is at least within (e.g., the coverage zone of) one of the configured reference points.

A WTRU that is configured and/or indicated with second type (e.g., zone-based) MOs based on one or more spatial zones may determine to monitor a subset of beam resources (e.g., LP-SS, SSB). For example, the WTRU may determine the subset of beam resources based on one or more quality parameter measurements before the WTRU switched to an MR-OFF mode. In an example, the quality parameters may be RSRP, RSRQ, LP-RSRP, or LP-RSRQ. In an example, the WTRU may be configured and/or indicated with the subset of beam resources associated with the configured spatial zone. For example, the WTRU may receive the configuration information and/or indications on the subset of beam resources, for example via RRC, MAC-CE, DCI, or SIB. In an example, the WTRU may receive the configuration information and/or indications on the subset of beam resources as part of RRC release signaling, for example before switching to an MR-OFF mode.

In an embodiment, a WTRU may receive, monitor, and/or measure one or more quality parameters of the associated subset of beam resources based on one or more RSs (e.g., SSBs or LP-SSs associated with the configured zone). The WTRU may monitor beam quality of the associated subset of beam resources for example, periodically, in each MO. The WTRU may determine that the WTRU is in-zone with respect to the configured spatial zone if at least one of the measured quality parameters is higher than a corresponding determined, configured, and/or indicated threshold. The WTRU may determine that the WTRU is out-of-zone with respect to the configured spatial zone if all of the measured quality parameters are lower than the corresponding threshold.

A WTRU may determine that the WTRU is in-zone with respect to a configured first zone. In case the WTRU is in-zone with respect to the configured first zone, the WTRU may monitor one or more configured second type (e.g., zone-based) MOs in one or more configured LOs to detect and/or receive a LP-WUS. At a time, one of a plurality of candidate codepoint values may be transmitted in a second type MO, which may be associated with one or multiple WTRU subgroups (WSG).

In an embodiment, a WTRU may determine, be configured, and/or indicated with one or more first codepoints and second codepoints to be monitored, detected, and/or received in first type MOs and second type MOs, respectively. For example, the codepoints may be associated with one or more WTRUs and WSGs. In an example, the WTRU may monitor the first type (e.g., legacy) MOs based on the first codepoints, whereas the WTRU may monitor the second type (e.g., zone-based) MOs based on the second codepoints.

In an example, the first codepoints may be based on (pre)configured WSGs, for example according to WTRU_ID based subgrouping and/or core network (CN) assigned subgrouping. In another example, the second codepoints may be associated with one or more configured zones. That is, the second codepoints may be zone-based codepoints. In an example, the WTRU in a first zone may be indicated and/or configured to monitor to detect and/or receive a first zone-based codepoint associated with a first WSG, whereas a WTRU in a second zone may be indicated and/or configured to monitor to detect and/or receive a second zone-based codepoint associated with the first WSG. That is, the same WSG may be indicated via different codepoints, where the different codepoints may be associated with different zones.

In an example, the WTRU may be configured and/or indicated with the second codepoints based on one or more of the following.

The WTRU may be configured and/or indicated with the second codepoints based on sequences (e.g. overlaid sequence). In an example, a WTRU may be configured and/or indicated with a first set of overlaid sequences for detecting and/or receiving one or more LP-WUS codepoints. For example, the WTRU may use the configured first set of overlaid sequences in first type (e.g., legacy) MOs. In an example where the WTRU receives a first sequence associated with WSG-1 in MO 325 in FIG. 3 associated with Beam1, the WTRU receives a second sequence associated with WSG-y in the MO 360 associated with Beam m.

In another example, the WTRU may be configured with a zone-based supplementary sequence, where the WTRU may determine and/or calculate a second (e.g., overlaid) sequence based on adding the configured first set of sequences with the configured zone-based supplementary sequence. In an example, the WTRU receives a sequence that is resultant of adding the sequence associated with WSG-a (MO 305 in FIG. 3) with the sequence associated with Zone 1 (e.g., WSG-a+Zone1Seq). The benefit for using a zone-based sequence is to reduce the probability of error as well as probability of misdetection. Moreover, the zone-based sequences reduce the probability of collisions from other sequences, since the WTRU that is in-zone with respect to a first zone expects to receive sequences that are generated based on the zone-based supplementary sequence that is associated with the first zone.

In an example, the WTRU may determine, be indicated, and/or configured to use a first set of (e.g., overlaid) sequences in the first type (e.g., legacy) MOs, for example when the WTRU is out-of-zone with respect to a configured zone. In another example, the WTRU may determine, be indicated, and/or configured to use a second set of (e.g., zone-based) (e.g., overlaid) sequences in the second type (e.g., zone-based) MOs, for example when WTRU is in-zone with respect to the configured zone.

The WTRU may be configured and/or indicated with the second codepoints based on configured WTRU-IDs. In an example, a WTRU may be configured and/or indicated with a first set of WTRU_ID and/or CN-based subgroups. For example, the WTRU may use the configured first set of (e.g., overlaid) sequences in first type (e.g., legacy) MOs. In another example, the WTRU may be configured with a zone-based WTRU-ID, where the WTRU may receive the zone-based WTRU-ID via, for example, RRC, MAC-CE, DCI, SIB and/or as part of an RRC release message, for example before switching to an MR-OFF mode.

The benefit for using a zone-based WTRU-ID is that the subgrouping may be done differently, for example with higher granularity, for in-zone, for example local, WTRUs. As such, the WTRU may use the zone-based WTRU-ID only if the WTRU is in-zone with respect to a configured zone and the WTRU uses the normal, legacy, first WTRU_ID in case the WTRU is out-of-zone.

The WTRU may be configured and/or indicated with the second codepoints based on scrambled codepoints. In an example, a WTRU may be configured and/or indicated with a first set of codepoints and a zone-based second set of codepoints, where the second set of codepoints may be a different (e.g., scrambled) version of the first codepoints. The WTRU may receive the configuration information and/or indications regarding the second set of codepoints, for example via RRC, MAC-CE, DCI, SIB, and/or as part of an RRC release message, for example before switching to an MR-OFF mode.

The benefit for using a zone-based (e.g., scrambled) codepoint is that the probability of potential interference and/or collision from transmission of codepoints in other MOs may be reduced.

A WTRU may be configured with one or more zones, for example based on the last cell that the WTRU had camped on or the last cell that the WTRU was connected to. The WTRU may be configured with one or more zones, for example based on WTRU's last location and/or radio and/or beam quality in the last cell that the WTRU had camped, for example before WTRU switched to an MR-OFF mode. The WTRU may receive one or more configuration information, indications, and/or threshold values, as described herein.

A WTRU may be in an out-of-zone condition. In an embodiment, a WTRU may stop monitoring LP-WUS in second type (e.g., zone-based) MOs based on one or more configuration, indications, conditions, and/or threshold values. For example, the WTRU may receive one or more configuration information and/or indications, for example via RRC signaling, MAC-CE indication, DCI indication, or system information. In addition, the WTRU may determine, be configured, and/or indicated with one or more conditions, for example if the WTRU is in-zone or out-of-zone with respect to a configured zone. One or more of the following examples may apply.

In an example, the WTRU may receive a message (e.g., RRC release message or non-access stratum (NAS) message) from the network that includes a zone configuration (e.g., geographical location) for monitoring LP-WUS in zone-based MOs.

In an example, the configured zone may comprise one or more cells (e.g., cell IDs, PCI, cell ID with BWP ID, cell ID with associated beams) where each of the cells may support and/or have the capability to perform downlink transmission for LP-WUS signals (e.g., LP-SS) to LP-WUS WTRUs. For example, the configured zone for monitoring LP-WUS may be configured separately based on LP-WUS receiver type (e.g., OOK-based or OFDM-based) and based on the LP-WUS signals (e.g., LP-SS or SSB).

In an example, the WTRU may receive a configuration of a configured zone in addition to one or more measurement values and/or corresponding thresholds for evaluation of in-zone or out-of-zone (e.g., LP-RSRP value and/or LP-RSRQ value). For example, the WTRU may receive a threshold value with regards to the measured LP-RSRP value and/or LP-RSRQ value for evaluation of in-zone condition. For example, in case the measured value is below the threshold, the WTRU may determine that the WTRU may be in out-of-zone condition. For example, the threshold value for evaluation of in-zone condition may be configured separately based on LP-WUS receiver type (e.g., OOK-based or OFDM-based) and based on the LP-WUS signals (e.g., LP-SS or SSB).

In an example, the WTRU may determine, be configured, and/or indicated with a timer value to evaluate an out-of-zone condition. For example, the WTRU may consider to be in in-zone condition with regards to the configured zone when the WTRU receives at least one valid LP-WUS signal (e.g., with measured quality parameters above the corresponding threshold) while the timer is running. In an example, the WTRU may perform measurements and determine if the WTRU is in-zone or out-of-zone with respect to the configured zone in case the timer expires. After the timer expires, in case the measured quality parameters are higher than the corresponding threshold, the WTRU may restart and/or reinitiate the timer. In case the measured quality parameters are lower than the corresponding threshold, the WTRU may determine to be out-of-zone.

In an example, the WTRU may determine to be out-of-zone when the cell that the WTRU is camping on is not included in the configured zone.

In an embodiment, a WTRU may determine, be configured, and/or indicated with one or more candidate zones in addition to a configured zone. In an example, the WTRU may receive the configuration on the candidate zones via for example, RRC, MAC-CE, DCI, or SIB based on the last cell that the WTRU had camped, based on the WTRU's location within the last cell, for example before the WTRU switched to an MR-OFF mode. In another example, the WTRU may receive the configuration on the candidate zones via RRC release message.

In an example, the WTRU may determine, be indicated, and/or configured with one or more candidate zones, where the candidate zones may be of different types. In an example, the WTRU may be configured with a first candidate zone that may be based on a geographical zone. The WTRU may be configured with a second candidate zone that may be based on a spatial zone. For example, the WTRU may receive one or more configuration information based on the configured candidate zones and corresponding zone types for the configured candidate zones. In an example, the WTRU may receive configuration information including but not limited to one or more geographic coordinates for one or more reference points or one or more threshold values for a geographic zone. In another example, the WTRU may receive configuration information including but not limited to one or more beam resources, quality parameters, or threshold values for a spatial zone.

In an embodiment, in case the WTRU determines that the WTRU is out-of-zone with regards to a configured first zone, the WTRU may determine to select a second zone from the candidate zones to monitor for receiving and/or detecting LP-WUS. One or more of the following example steps may apply.

The WTRU may determine one or more candidate zones out of all of the configured candidate zones, with respect to which the WTRU is in-zone.

In case of geographic candidate zones, the WTRU may select the second zone based on the WTRU's location, candidate zone's geographic coordinates, WTRU's velocity, and/or WTRU 's direction. For example, the WTRU may select the second zone based on the candidate zone that the WTRU is located within its respective coordinates and that WTRU may stay inside the coordinates based on the WTRU's velocity and direction. The WTRU may use an algorithm for determining the second zone out of the candidate zones.

In case of spatial candidate zones, the WTRU may measure one or more quality parameters based on one or more subset of beam resources associated with one or more candidate zones. The WTRU may select the second zone based on WTRU's location and/or measured quality parameters. For example, the WTRU may select the second zone based on the candidate zone that includes a beam resource (e.g., LP-SS) with the highest measured quality parameter (e.g., highest RSRP, RSRQ, LP-RSRP, LP-RSRQ).

In an embodiment, after selecting a second zone out of the configured candidate zones, the WTRU may use the LOs and second type (e.g., zone-based) MOs associated with the selected second zones for monitoring, detecting, and/or receiving LP-WUS. In an example, the WTRU may determine, be (pre)configured, and/or indicated with one or more configuration information regarding the LOs, first type (e.g., legacy) MOs, and second type MOs, corresponding to the second zone, for example at the time of receiving configuration information on the candidate zones. In another example, the WTRU may be configured to use indicated and/or configured different configuration on the LOs, number of MOs, periodicity, time and frequency resources, first type MOs, and second type MOs, configured for each of the candidate zones. In another example, the WTRU may be configured to use the same configuration on the LOs, number of MOs, periodicity, time and frequency resources, first type MOs, and second type MOs, configured for the first zone in one or more of the configured candidate zones. For example, the WTRU may receive an explicit indication to consider the configurations on MOs and LOs in the candidate zones to be the same as the first zone. In another example, in case of absence of indication and/or configuration information on MOs and LOs in the candidate zones, the WTRU may determine that the configurations on LOs and MOs in the candidate zones may be the same as the first zone.

Considering the zone-based MOs, the network (e.g., gNB, Node-B, based station) may transmit LP-WUS for the WTRU that is supposed to be “in zone” with respect to the last camped on cell, WTRU's last location, and/or WTRU's last TCI-state, for example before the WTRU switched to an MR-OFF mode. The gNB may continue sending LP-WUS for the WTRU in zone-based MOs as long as the gNB receives responses from the WTRU. If the WTRU does not respond to a transmitted LP-WUS in zone-based MOs, for example, due to the WTRU being out of zone, the gNB may send LP-WUS for the WTRU (for example one-by-one or all at once) in the configured candidate zones. In case the gNB receives a response from the WTRU in at least one of the second zones (e.g., out of the configured candidate zones), the gNB may consider the second zone as the WTRU's zone and continues sending LP-WUS to the WTRU according to the second zone.

A WTRU may fallback to monitoring first type (e.g. legacy) MOs. In an example, a WTRU that has determined to be out-of-zone with respect to its first configured zone may verify if the WTRU is in-zone with at least one of the candidate zones, if configured. In case the WTRU is out-of-zone with regards to the first configured zone and all candidate zones, the WTRU may determine to stop monitoring second type (e.g., zone-based) MOs and to fallback to monitoring first type (e.g., legacy) MOs.

In another example, a WTRU that is in-zone with respect to its configured first zone may determine that the beam quality and/or radio quality may be lower than a corresponding threshold. For example, the WTRU may measure one or more determined, indicated, and/or configured quality parameters (e.g., RSRP, RSRQ, LP-RSRP, LP-RSRQ) where none of the measured quality parameters may be higher than corresponding thresholds. In an example, the WTRU may determine that the measured low value of the quality parameters may be due to beam failure or blockage. In such a case, the WTRU may determine to stop monitoring second type (e.g., zone-based) MOs and to fallback to monitoring first type (e.g., legacy) MOs.

Considering the zone-based MOs, the network (e.g., gNB, Node-B, base station) may transmit LP-WUS for the WTRU that is supposed to be “in zone” with respect to the last camped on cell, WTRU's last location or WTRU's last TCI-state, for example before the WTRU switched to an MR-OFF mode. The gNB may continue sending LP-WUS for the WTRU in zone-based MOs as long as the gNB receives responses from the WTRU. If the WTRU does not respond to the transmitted LP-WUS in zone-based MOs, for example, due to the WTRU being out of zone, the gNB may send LP-WUS for the WTRU (for example one-by-one or all at once) in the configured candidate zones. In case the gNB does not receive a response from the WTRU in any of the second zones (e.g., out of the configured candidate zones), the gNB may consider the WTRU to be out-of-zone. As such the gNB may consider the WTRU has fallen back to first type (e.g., legacy) MOs, so the gNB may transmit LP-WUS for the WTRU in first type (e.g., legacy) MOs.

A WTRU may report an out-of-zone condition. For example, the WTRU may send the report in case the WTRU is in an RRC-Connected State, or after switching to an RRC-Connected State from an RRC-Idle and/or RRC-Inactive State. In another example, the WTRU may perform a (e.g., special) RACH operation in case the WTRU is in an RRC-Idle or RRC-Inactive mode. For example, the WTRU may send a (e.g., special) PRACH preamble that the WTRU may be (pre)configured and/or indicated with, for indication of “out-of-zone” condition. In another example, the WTRU may send a PRACH preamble in one or more (e.g., special) RACH occasions (RO) that the WTRU may be (pre)configured and/or indicated with, for indication of “out-of-zone” condition.

For example, the WTRU may report out-of-zone (e.g., geographical zone, spatial zone, low radio quality measurements) condition, for example to the network (e.g. gNB, Node-B, base station).

For example, the WTRU may be configured and/or indicated to report the out-of-zone condition. The WTRU may receive related reporting uplink resource configuration (e.g., via or as part of negative acknowledgment (NACK), UCI, special SR, MAC-CE, RACH, small data transfer (SDT), RRC message, RO) with associated reporting conditions. The reporting conditions may comprise the WTRU's RRC State (e.g., RRC-Connected, Idle, and/or Inactive) and/or events of in-zone or out-of-zone (e.g., out of the desired geographical location and/or spatial zones).

For example, the WTRU may determine, be configured, and/or indicated to report when the WTRU is out-of-zone condition when the WTRU is connected to a cell and the measured LP-RSRP and/or LP-RSRQ value from the cell is below the threshold. For example, the WTRU may report reception failure based on the in-zone conditions.

For example, the WTRU may determine, be configured, and/or indicated to report when the WTRU is in an out-of-zone condition when the WTRU is camped on a cell which is not included in the configured zone.

For example, the WTRU may determine, be configured, and/or indicated to report when the WTRU is in an out-of-zone condition when the WTRU is camping on a cell which is included in the configured valid zone, however the measured quality parameters from the camping cell may be below the threshold, for example, due to beam failure or blockage.

In an embodiment, the WTRU may determine that the WTRU may be out-of-zone when WTRU receives (e.g., an explicit) an indication (e.g., via RRC, MAC-CE, or DCI, where the indication may indicate that the WTRU should stop monitoring second type (e.g., zone-based) MOs. In an example, based on the indication, the WTRU may monitor first type (e.g., legacy) MOs. In another example, based on the indication, the WTRU may wake up the MR.

In an embodiment, the WTRU may report the out-of-zone condition if the number of consecutive reception failures of LP-SS and/or LP-WUS signal occurs. For example, the WTRU may send a response via or as part of a NACK, UCI, SR, MAC CE, or RRC message.

In an embodiment, in case the WTRU is camping to a cell which is not included in the configured zone, the WTRU may send an indication (i.e., out-of-zone indication) via a configured grant for SDT or via a RACH procedure (e.g., via MSG1, MSG3, MSGA, MSGB).

In an embodiment, when the WTRU is camping on a cell which is included in the configured valid zone and the measured quality parameters from the camping cell is below the threshold, the WTRU may report a response (i.e., number of failures) via a configured grant for SDT or during a RACH procedure (e.g., via MSG1, MSG3, MSGA, MSGB)

In an embodiment, the WTRU may wake up the MR and report and/or indicate the selected first LP-SS. The WTRU may send the indication via a RACH procedure (e.g., MSG1, MSG3, MSGA, MSGB).

In an embodiment, a WTRU that is configured with a first zone may determine a second zone for the WTRU to switch to, where the WTRU may report the “out of zone” condition with respect the first zone and/or the change to the second zone. For example, the WTRU may determine and/or select the second zone based on one or more configured candidate zones. In an example, the WTRU may determine the second zone based on the WTRU's coordinates and one or more zone coordinates, Cell-IDs, or Beam IDs. In an example, the WTRU may be (pre)configured and/or indicated with the geographical coordinates of one or more adjacent and/or close-by zones. In an example, the WTRU may be (pre)configured with one or more Cell-IDs for one or more adjacent and/or close-by cells. In an example, the WTRU may be (pre)configured with one or more Beam IDs, where the Beam IDs may be associated with one or more SSB Index, LP-SS Index, or CSI-RS Resource Indicator (CRI).

The WTRU may report the “out of zone” condition and/or change of zone based on one or more of the following.

For example, a set of PRACH resources may be reserved for zone indication or notification, where each PRACH resource may be associated with a zone. The WTRU may determine a PRACH resource which may be associated with a determined or changed zone. In an example, the set of PRACH resources may be dedicated to a WTRU. In an example, the set of PRACH resources may be configured per zone.

For example, a WTRU-ID may be included or indicated when a WTRU transmits PRACH for “out of zone” and/or change of zone indication. The WTRU may transmit a PUSCH associated with the PRACH, wherein the PUSCH may include the WTRU-ID. For example, the WTRU-ID may be IMSI or s-TMSI or modulo of IMSI or s-TMSI. The PUSCH associated with the PRACH may be transmitted in a (pre)determined, (pre)configured, and/or (pre)indicated time and/or frequency resources which may be dedicated to each PRACH resource configured for an “out of zone”and/or change of zone indication or notification.

For example, a set of grant-free uplink transmission resources may be used for “out of zone” and/or change of zone indication or notification. For example, a grant-free uplink transmission resource may comprise at least one of a sequence (e.g., PRACH sequence), data (e.g., PUSCH), and uplink control (e.g., PUCCH) configuration and/or resources.

For example, a WTRU may monitor to receive a confirmation, for example, from a gNB. For example, after a WTRU sends an “out of zone” and/or change of zone indication or notification, the WTRU may monitor one or more PDCCH, or LP-WUS MOs for the confirmation of an “out of zone” and/or change of zone in the determined or changed zones.

In an embodiment, a beam-related and/or zone-related information for a WTRU may be stored at a network (e.g., MME or gNB). For example, the latest beam-related and/or zone-related information for a WTRU may be stored in a network for LP-WUS and/or paging, for example when the WTRU switches from an RRC-Connected state to RRC-Idle or RRC-Inactive state. The latest beam-related information may include at least one of SSB Index, LP-SS index, TCI-state, Beam-ID, and/or beam group ID. The latest zone-related information may include at least one of geographical coordinates and/or zone ID. For example, when the WTRU is paged, the MME may provide beam-related information for the WTRU to a gNB within a zone.

Reporting may be triggered by the network. In an embodiment, a WTRU may receive one or more indications to change from a first configured zone to a second zone. For example, the WTRU may receive the indication via LP-WUS signaling. In an example, the WTRU may receive the indication, for example, from a gNB, where the gNB may trigger a change of zone for LP-WUS monitoring. The indication may include, for example, the second zone's ID, coordinates, and beam ID.

In an embodiment, a WTRU may receive one or more indications to report one or more (pre)configured and/or indicated information regarding the WTRU's zone and/or beam. For example, the WTRU may receive the indication via LP-WUS signaling. The indication may be received via a common or group-common LP-WUS signaling, which may be used for all zones and/or beams, where the indication may indicate or trigger a zone reporting from a WTRU or a group of WTRUs.

For example, the LP-WUS may include a bit field which may trigger a zone and/or beam reporting from a WTRU or a group of WTRUs. In an example, the group of WTRUs may be determined based on geographical coordinates. For example, if the LP-WUS triggers geographical zone reporting, the WTRUs monitoring LP-WUS “zone-based” MOs associated with the same geographical zone may report their geographical coordinates, zones, and/or beams. In an example, the group of WTRUs may be determined based on the associated SSB. For example, WTRUs monitoring LP-WUS associated with an SSB may be determined as a group of the WTRU. If the LP-WUS triggers beam reporting, the WTRUs monitoring LP-WUS MOs associated with the same SSB may report zones and/or beams.

For example, a set of PRACH resources may be used for zone and/or beam reporting and the set of PRACH resources to use may be indicated in the LP-WUS. For example, one or more sets of PRACH resources for the reporting may be (pre)configured and/or (pre)defined and one of the sets may be indicated in the LP-WUS when a reporting is triggered. In an example, the received LP-WUS may be a common LP-WUS which may be monitored by all WTRUs.

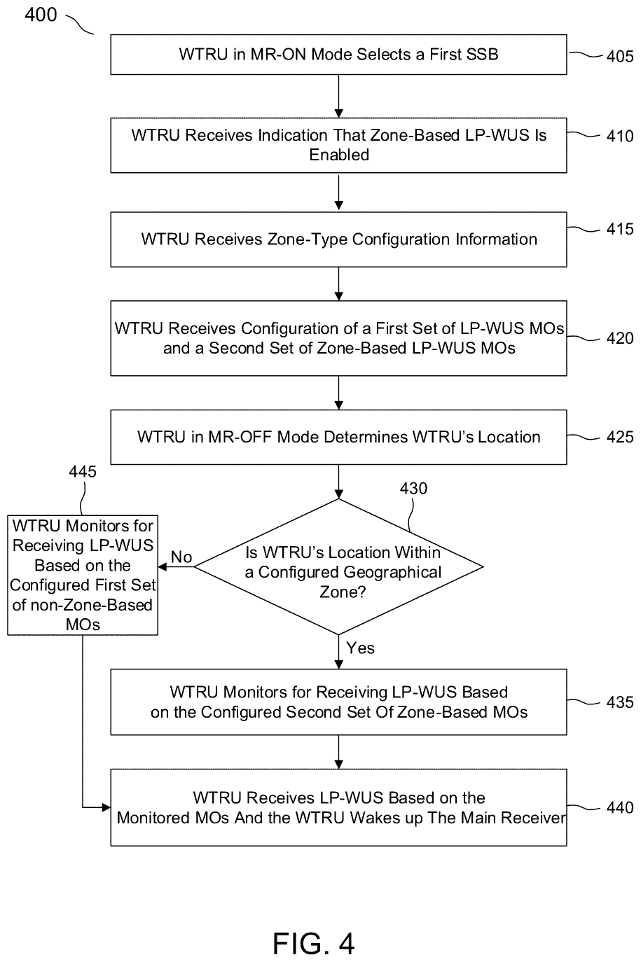

FIG. 4 shows an example method 400 for using geographical zone-based low-power wake-up signal (LP-WUS) monitoring occasions (MOs).

A WTRU may comprise a main radio receiver (MR) and a low power wake up receiver (LP-WUR). The WTRU may comprise a transceiver that may comprise a MR and LP-WUR. The transceiver may be switchable between a MR mode and a LP-WUR mode.

A WTRU may be configured to receive, measure, and/or select a first synchronization signal block (SSB) 405. The WTRU may report the selected SSB to a network entity. The network entity may be a gNB, NodeB, TRP, sidelink WTRU, access point, or base station. The selected SSB may correspond to a best receive beam. The WTRU may be in an RRC-Connected state or mode. The WTRU may be in a first cell. The WTRU may be operating with its main radio (MR) in an on mode (MR-ON). The WTRU may report the selected SSB to the gNB.

The WTRU may be configured to receive LP-WUS configurations(s) and/or indication(s) from a network entity (e.g. gNB). The configurations(s) and/or indication(s) may be received in a system information block (SIB), for example SIB1, in a master information block (MIB), in a MAC-CE, in a DCI, or via RRC signaling. The configurations(s) and/or indication(s) may be received in a same message or different messages.

The WTRU may receive, from a gNB, an indication that zone-based LP-WUS is enabled 410. The received indication may be in response to the reported selected SSB. For example, the indication may be a flag indication on whether the second type zone-based LP-WUS MO is enabled. For example, a first value of the received indication (e.g., value one) may indicate that the second type zone-based LP-WUS MO is enabled and a second value of the received indication (e.g., value zero) may indicate that the second type zone-based LP-WUS MO is disabled or not enabled. The indication may be cell-common, group-specific, and/or WTRU-specific.

The WTRU may be configured to receive, from the gNB, zone type configuration information 415. The WTRU may be configured with one or more zone types including but not limited to geographic zones and spatial zones. The zone type configuration information may indicate a geographical zone or zones including latitude and longitude coordinates. The geographical zone may be associated with the WTRU's current location. The zone type configuration information may indicate a spatial zone or zones including one or more threshold values, beam resource sets, including SSBs, LP-SSs, and/or TCI-states associated with the selected first SSB and/or the first cell. The zone type configuration information may comprise or indicate one or more threshold values or delta offset values corresponding to the configured zone type.

The WTRU may be configured to receive, from the gNB, LP-WUS MO configuration information 420. The LP-WUS MO configuration information may comprise information regarding a first set (e.g. legacy, non-zone based) LP-WUS MOs, and a second set of zone-based LP-WUS MOs. The LP-WUS MO configuration information may comprise information regarding a first set of overlaid sequences and associated codepoints, DRX occasions, LP-WUS transmission occasions (LO), and LP-WUS MO.

The WTRU may determine its current location 425. The WTRU may determine its current location with its MR in an off mode (MR-OFF). The WTRU may be in an RRC-IDLE or RRC-INACTIVE state or mode.

The WTRU may determine, based on its determined location, whether it is inside (in-zone) or outside (out-of-zone) of the configured geographical zone 430. The WTRU may determine whether it is in-zone or out-of-zone based on, for example, geographical coordinates, distance from one or more configured reference points, a Reference Signal Time Difference (RSTD), and/or one or more RRM measurements.

If the WTRU determines that it is in-zone, the WTRU may monitor for receiving a LP-WUS based on or using the configured 2^{nd} set of zone-based MOs 435. The WTRU may monitor the 2^{nd} set of zone-based MOs based on a second set of overlaid sequences. The second set of overlaid sequences may be generated based on the configured first set of overlaid sequences associated with a codepoint added with a second zone-based sequence that is associated with the configured zone.

The gNB may transmit a LP-WUS for a WTRU that is supposed to be in zone as long as the gNB receives response(s) from the WTRU. If the WTRU does not respond to a transmitted LP-WUS in zone-based MOs due to, for example the WTRU being out of zone, the gNB may sends a LP-WUS for the WTRU in the 1^{st} set of non-zone-based (legacy) MOs.

The WTRU may receive a LP-WUS based on the 2^{nd} set of zone-based monitored MOs and wake up the MR and switch to a MR-ON mode 440. The WTRU may monitor a paging occasion (PO) and receive a PDCCH transmission. The WTRU may be indicated or receive in indication via the PDCCH to receive a downlink transmission or to transmit an uplink transmission or PRACH transmission. The WTRU may indicate a selected first LP-SS as part of a configured UL message (e.g. Msg3 or MsgB).

The WTRU may determine to monitor for receiving a LP-WUS based on the 1^{st} set of non-zone-based (legacy) MOs 445. The WTRU may determine to monitor for receiving a LP-WUS based on the 1^{st} set of non-zone-based (legacy) MOs if the WTRU determines that it is out-of-zone 430. The WTRU may determine to monitor for receiving a LP-WUS based on the 1^{st} set of non-zone-based (legacy) MOs if beam blockage occurs. Beam blockage may occur if the measured LP-SS is low quality. The WTRU may receive a LP-WUS based on the monitored 1^{st} set of MOs and wake up the MR and switch to a MR-ON mode 440. The WTRU may monitor an associated PO and receive a PDCCH transmission. The WTRU may be indicated or receive in indication via the PDCCH to receive a downlink transmission or to transmit an uplink transmission or PRACH transmission.

The WTRU may wake up its MR and send an indication to the gNB to report an out-of-zone condition.

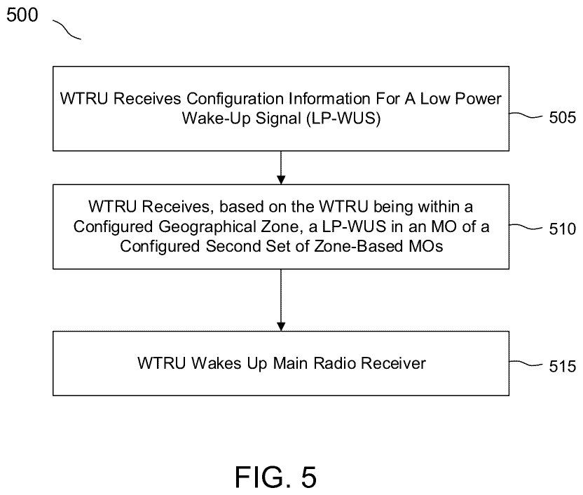

FIG. 5 shows an example method 500 for using geographical zone-based low-power wake-up signal (LP-WUS) monitoring occasions (MOs).

A WTRU may be configured to receive configuration information for a low power wake-up signal (LP-WUS) from a network entity 505. The network entity may be a gNB, NodeB, or base station. The WTRU may be operating with its main radio (MR) in an on mode (MR-ON). The WTRU may be operating in a first cell. The WTRU may be in an RRC-Connected state or mode. The LP-WUS configuration information may comprise one or more indications. The LP-WUS configuration information may be received in a system information block (SIB) (e.g. SIB1), in a master information block (MIB), in a MAC-CE, in a DCI, or via RRC signaling. The indications in the LP-WUS may be received in a same message or different messages. The WTRU may receive the LP-WUS configuration information in response to reporting a selected SSB to the gNB. The selected SSB may correspond to a best receive beam.

The configuration information may comprise an indication that zone-based LP-WUS is enabled. For example, the indication may be a flag indication on whether the second type zone-based LP-WUS MO is enabled. For example, a first value of the received indication (e.g., value one) may indicate that the second type zone-based LP-WUS MO is enabled and a second value of the received indication (e.g., value zero) may indicate that the second type zone-based LP-WUS MO is disabled or not enabled. The indication may be cell-common, group-specific, and/or WTRU-specific.

The configuration information may comprise zone type configuration information or indication. The WTR may be configured with one or more zone types including but not limited to geographic zones and spatial zones. The zone type configuration information may indicate a geographical zone or zones including latitude and longitude coordinates. The geographical zone may be associated with the WTRU's current location. The zone type configuration information may indicate a spatial zone or zones including one or more threshold values, beam resource sets, including SSBs, LP-SSs, and/or TCI-states associated with the selected first SSB and/or the first cell. The zone type configuration information may comprise or indicate one or more threshold values or delta offset values corresponding to the configured zone type.

The configuration information may comprise LP-WUS MO configuration information or indication. The LP-WUS MO configuration information may comprise information regarding a first set (e.g. legacy, non-zone based) LP-WUS MOs, and a second set of zone-based LP-WUS MOs. The LP-WUS MO configuration information may comprise information regarding a first set of overlaid sequences and associated codepoints, DRX occasions, LP-WUS transmission occasions (LO), and LP-WUS MO.

The WTRU may determine, based on its current location, that it is inside (in-zone) of the configured geographical zone. The WTRU may determine whether that it is in-zone based on, for example, geographical coordinates, distance from one or more configured reference points, a Reference Signal Time Difference (RSTD), and/or one or more RRM measurements. The WTRU may determine its current location with its MR in an off mode (MR-OFF). The WTRU may be in an RRC-IDLE or RRC-INACTIVE state or mode.

The WTRU may monitor for and receive, based on the WTRU being within a configured geographical zone, a LP-WUS in an MO of the 2^{nd} set of zone-based MOs 510. The WTRU may monitor the 2^{nd} set of zone-based MOs based on a second set of overlaid sequences. The second set of overlaid sequences may be generated based on the configured first set of overlaid sequences associated with a codepoint added with a second zone-based sequence that is associated with the configured zone.

The gNB may transmit a LP-WUS for a WTRU that is supposed to be in zone as long as the gNB receives response(s) from the WTRU. If the WTRU does not respond to a transmitted LP-WUS in zone-based MOs due to, for example the WTRU being out of zone, the gNB may sends a LP-WUS for the WTRU in the 1^{st} set of non-zone-based (legacy) MOs.

The WTRU may wake up the MR and switch to a MR-ON mode 515. The WTRU may monitor a paging occasion (PO) and receive a PDCCH transmission. The WTRU may be indicated or receive in indication via the PDCCH to receive a downlink transmission or to transmit an uplink transmission or PRACH transmission. The WTRU may indicate a selected first LP-SS as part of a configured UL message (e.g. Msg3 or MsgB).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
receiving configuration information for a low power wake-up signal (LP-WUS), the configuration information indicating 1) zone-based LP-WUS being enabled, 2) a zone-type configuration, and 3) an LP-WUS monitoring occasion (MO) configuration of a first set of non-zone-based MOs and a second set of zone-based MOs;
receiving, based on the WTRU being within a configured geographical zone, a LP-WUS in an MO of the second set of zone-based MOs; and
waking up a main radio receiver based on the received LP-WUS.

2. The method of claim 1, wherein the configuration information is received from a network entity, wherein the network entity is a gNB.

3. The method of claim 1, wherein the configuration information is received using the main radio receiver in an on mode and wherein the WTRU is in a radio resource control connected mode (RRC-Connected).

4. The method of claim 1, wherein the configuration information is received in a system information block (SIB), a master information block (MIB), a medium access control-control element (MAC-CE), a downlink control information (DCI), or via radio resource control (RRC) signaling.

5. The method of claim 1, wherein the zone-type configuration indicates a geographical zone including latitude and longitude coordinates.

6. The method of claim 1, further comprising:
determining that the WTRU is within the configured geographical zone based on at least one of: latitude and longitude coordinates, a distance from one or more configured reference points, a Reference Signal Time Difference (RSTD), or one or more radio resource management (RRM) measurements.

7. The method of claim 1, wherein the configuration information further comprises information regarding a first set of overlaid sequences and associated codepoints.

8. The method of claim 1, further comprising:
monitoring for the LP-WUS using the second set of zone-based MOs based on a second set of overlaid sequences.

9. The method of claim 8, wherein the second set of overlaid sequences is based on a configured first set of overlaid sequences associated with a codepoint added with a second zone-based sequence that is associated with the configured geographical zone.

10. The method of claim 1, further comprising:
monitoring a paging occasion (PO) for paging messages and receiving a physical downlink control channel (PDCCH) transmission after turning on the main radio receiver.

11. A wireless transmit/receive unit (WTRU) comprising:
at least one transceiver comprising a main radio receiver and a low power wake up radio receiver (LP-WUR); and
a processor, wherein:
the main radio receiver of the at least one transceiver and the processor are configured to receive configuration information for a low power wake-up signal (LP-WUS), the configuration information indicating 1) zone-based LP-WUS being enabled, 2) a zone-type configuration, and 3) an LP-WUS monitoring occasion (MO) configuration of a first set of non-zone-based MOs and a second set of zone-based MOs;
the processor and the LP-WUR of the at least one transceiver are configured to receive, based on the WTRU being within a configured geographical zone, a LP-WUS in an MO of the second set of zone-based MOs; and
the processor is configured to wake up the main radio receiver of the at least one transceiver based on the received LP-WUS.

12. The WTRU of claim 11, wherein the configuration information is received from a network entity, wherein the network entity is a gNB.

13. The WTRU of claim 11, wherein the configuration information is received using the main radio receiver in an on mode and wherein the WTRU is in a radio resource control connected mode (RRC-Connected).

14. The WTRU of claim 11, wherein the configuration information is received in a system information block (SIB), a master information block (MIB), a medium access control-control element (MAC-CE), a downlink control information (DCI), or via radio resource control (RRC) signaling.

15. The WTRU of claim 11, wherein the zone-type configuration indicates a geographical zone including latitude and longitude coordinates.

16. The WTRU of claim 11, wherein the processor is further configured to determine that the WTRU is within the configured geographical zone based on at least one of: latitude and longitude coordinates, a distance from one or more configured reference points, a Reference Signal Time Difference (RSTD), or one or more radio resource management (RRM) measurements.

17. The WTRU of claim 11, wherein the configuration information further comprises information regarding a first set of overlaid sequences and associated codepoints.

18. The WTRU of claim 11, wherein the LP-WUR is further configured to monitor for the LP-WUS using the second set of zone-based MOs based on a second set of overlaid sequences.

19. The WTRU of claim 18, wherein the second set of overlaid sequences is based on a configured first set of overlaid sequences associated with a codepoint added with a second zone-based sequence that is associated with the configured geographical zone.

20. The WTRU of claim 11, wherein the processor and the main radio receiver of the at least one transceiver is further configured to monitor a paging occasion (PO) for paging messages and receiving a physical downlink control channel (PDCCH) transmission after turning on the main radio receiver.
